(19) United States
(12) Patent Application Publication
(10) Pub. No.: US 2026/0250899 A1
(43) Pub. Date: Aug. 27, 2026

(54) CLOTHING TREATMENT APPARATUS

(71) Applicant: LG Electronics Inc., Seoul (KR)

(72) Inventors: Daewoong KIM, Seoul (KR); Jeongguen CHOI, Seoul (KR); Minkyu OH, Seoul (KR); Yeona JO, Seoul (KR); Yuna JO, Seoul (KR); Jaemyung LIM, Seoul (KR); Hyunki KIM, Seoul (KR); Sung Gul HWANG, Seoul (KR)

(21) Appl. No.: 18/707,115

(22) PCT Filed: Nov. 2, 2022
(86) PCT No.: PCT/KR2022/016995

§ 371 Date: May 6, 2026

(30) Foreign Application Priority Data
Nov. 2, 2021 (KR) 10-2021-0148504
Sep. 26, 2022 (KR) 10-2022-0121808
Nov. 1, 2022 (KR) 10-2022-0143994
Nov. 1, 2022 (KR) 10-2022-0143995

(51) Int. Cl. D06F 58/10; D06F 58/20; D06F 58/26

(52) U.S. Cl. CPC D06F 58/10; D06F 58/203; D06F 58/26; D06F 58/206

(57) ABSTRACT

The present disclosure relates to a clothing treatment apparatus comprising: a cabinet including an inlet on the front thereof; a door that opens and closes the inlet; a first chamber located inside the cabinet and accommodating clothes through the inlet; an auxiliary chamber located separately at a lower part of the first chamber inside the cabinet; a blowing unit provided in the auxiliary chamber to circulate air in the first chamber; an air supply duct provided in the auxiliary chamber and positioned close to one of both side surfaces of the cabinet to move air in the first chamber toward the blowing unit; a connection duct provided in the auxiliary chamber and including a heat exchange unit for heat exchange between air passing through the blowing unit and a refrigerant; and a discharge duct provided in the auxiliary chamber and positioned close to the other of one of the side surfaces of the cabinet to move the air passing through the connection duct to the first chamber.

### TECHNICAL FIELD

The present disclosure relates to a laundry treating apparatus. In detail, the present disclosure relates to a mechanical device that supplies hot air or steam to a space that accommodates laundry or goods therein, and a laundry support that hangs the laundry.

### BACKGROUND

A laundry treating apparatus refers to an apparatus developed for washing and drying laundry at home and in a laundry, and for removing wrinkles on the laundry. What is classified as the laundry treating apparatus includes a washing machine that washes the laundry, a dryer that dries the laundry, a washing machine/dryer that has both a washing function and a drying function, a clothes care apparatus that refreshes the laundry, a steamer that removes the wrinkles from the laundry, and the like.

In particular, the clothes care apparatus is an apparatus that helps keep the laundry fresh and clean. The clothes care apparatus may remove fine dust attached to the laundry, deodorize the laundry, dry the laundry, and add fragrance to the laundry. In addition, generation of static electricity may be prevented, wrinkles may be removed from the laundry using dehumidified air or steam, and the laundry may be sterilized.

Korean Patent Application Publication No. 10-2014-0108454 discloses a typical laundry treating apparatus. That is, in a case of the typical laundry treating apparatus, a treatment room in which the laundry is accommodated and cared for using steam and hot air is formed inside a cabinet, and a hanger bar where the laundry is hung extends in a left and right direction inside the treatment room. A machinery room containing mechanical devices necessary for the laundry caring may be located under the treatment room and may supply hot air and steam to the treatment room. Additionally, when the laundry is hung on the hanger bar using a hanger, the laundry may be disposed in a front and rear direction of the cabinet. Additionally, the treatment room may be equipped with a shelf where a bag, a hat, and other goods that require care may be mounted.

However, this is an apparatus that focuses on simply caring for the laundry. Therefore, there is no separate space to display or store laundry inside. Additionally, using the treatment room may not also be energy efficient when an amount of laundry to be cared for is small. In one example, when a front surface of the door is made of a transparent material such that a user may check the laundry hung inside, an insulation performance via the front surface of the door is reduced, making it difficult to achieve the purpose of laundry caring.

In addition, because the hanger bar may only move in the left and right direction from a fixed location, there may be inconvenience in the user having to reach inside the treatment room to hang the laundry when hanging the laundry.

In addition, with a development of clothes and accessories made of various materials, there may be a need for a space to separately store and display laundry that require delicate care, such as a leather product or a silk product, or a separate space where temperature and humidity may be adjusted on a regular basis to store and display items such as the bag or the hat.

Korean Patent Application Publication No. 10-2019-0141286 discloses a laundry treating apparatus that separately has the treatment room for accommodating therein and caring for the laundry and a storage room where laundry that has been cared for is stored and the temperature is adjustable. However, there is a problem in that the laundry treating apparatus takes up a great amount of space indoors because the treatment room and the storage room are arranged in the left and right direction. In addition, because an air conditioner for the storage room is not disposed separately, but an air conditioner for the treatment room is used in the storage room in a connected manner, independent temperature and humidity adjustment only for the laundry stored in the storage room is not available during use of the treatment room.

In one example, Korean Patent Application Publication No. 10-2019-0139400 discloses a laundry treating apparatus with the treatment room and the storage room divided from each other in the front and rear direction, but a laundry caring function is equipped only in the treatment room and there is no separate mechanical device to manage the temperature and the humidity of the storage room. When the laundry that has been treated or cared for is simply stored in the storage room, the stored laundry may be affected by changes in surrounding temperature and humidity. For example, when the laundry is stored without the temperature and humidity adjustment, a moisture content of the laundry may increase and the laundry may become damp, or surrounding odors may be absorbed again. To solve such problem, an apparatus to manage the temperature and the humidity of the laundry even during the storage is needed.

In addition, Korean Patent Application Publication No. 10-2019-0139400 discloses a laundry treating apparatus in which the treatment room on a front side and the storage room on a rear side are separated from each other and the treatment room is hinged to a side surface of the storage room. However, considering an usage environment in which the laundry treating apparatus is used, a size of the laundry treating apparatus has no choice but to consider a standard size of furniture such as a typical closet. This is because the laundry treating apparatus is disposed next to or adjacent to the closet rather than being disposed alone indoors, away from the closet. Therefore, when the treatment room and the storage room are coupled to each other in a form similar to the hinge coupling of the typical door, durability of the hinge may be a problem because of a size of the treatment room, and interference may occur with the furniture located near when the treatment room pivots relative to the storage room. To solve such problem, the laundry treating apparatus should protrude forward as much as the size of the treatment room to resolve the interference between the surrounding furniture and the hinge. However, when the laundry treating apparatus protrudes more than other furniture, sense of unity with the surrounding furniture may be ruined.

Additionally, a new hinge structure that may withstand loads of the structure for the display room and the structure for supporting the display room may be needed.

In one example, Korean Patent No. 10-2043197 shows a hanger bar disposed in a width direction to hang laundry inside. In the case of the hanger bar, there may be an inconvenience in that the user has to reach inside to hang the laundry.

Additionally, in Korean Patent No. 10-2043197, an air discharge port and an air intake port are disposed in a front and rear direction of the cabinet. However, when a size of a treatment room that accommodates the laundry therein becomes smaller, there may be cases in which the laundry is not be able to be hung along the width direction of the cabinet. In this case, when the air discharge port and the air intake port are disposed in the front and rear direction of the cabinet, air discharged from the air discharge port may not be supplied uniformly depending on a location where the laundry is hung.

To solve such problem, there is a need to change an arrangement of the air discharge port and the air intake port, which in turn requires changing an arrangement structure of a mechanical device that supplies air or steam. Rather than simply changing the arrangement of the mechanical device, it is necessary to prevent the laundry treating apparatus from overturning and optimize supply of air and steam to the first chamber by changing a center of gravity of the mechanical device. In addition, the change in the arrangement structure of the mechanical device must also consider changes in locations of a water supply tank and a drain tank.

### SUMMARY

### Technical Problem

First, the present disclosure is to provide a laundry treating apparatus with a space divided into a first chamber and a second chamber for caring of laundry or goods.

Second, the present disclosure is to provide the second chamber where temperature and humidity may be adjusted independently of the first chamber where temperature and humidity may be adjusted for sterilization, deodorization, drying, and wrinkle removal of laundry or goods.

Third, the present disclosure is to provide a hinge structure that may prevent interference with adjacent furniture when opening and closing a door assembly containing a second chamber, considering a size of the second chamber.

Fourth, the present disclosure is to provide a laundry treating apparatus where a hanger bar is disposed and an air circulation direction based on the hanger bar is set, considering a size of a space of the first chamber with a length in a front and rear direction reduced by the second chamber.

Fifth, the present disclosure is to provide a door assembly that may be automatically withdrawn from a cabinet by sensing opening of the door assembly by a user.

Sixth, the present disclosure is to enable check of laundry or goods accommodated in the second chamber via a front surface of the door assembly.

Seventh, the present disclosure is to provide a hanger body to improve convenience of a user.

Eighth, the present disclosure is to uniformly supply air or steam to laundry by changing arrangement of an air discharge port, an air intake port, and a steam discharge port based on a change in an arrangement direction of a hanger body.

Ninth, the present disclosure is to minimize occurrence of condensate on an inner surface of a door or a door assembly by changing arrangement of a steam discharge port.

Tenth, the present disclosure is to optimize an arrangement structure of a steam supply, an air supply, and the like and locations of a water supply tank and a drain tank based on a change in an arrangement of an air discharge port, an air intake port, and a steam discharge port.

### Technical Solutions

To solve the above-mentioned problems, the present disclosure provides a hanger body that is disposed in a front and rear direction of the cabinet and is extendable forward. In addition, considering user's convenience, the extended hanger body may be constructed to be rotatable, and may be rotated so as to be disposed along a width direction of the cabinet after being extended. Additionally, the present disclosure provides a laundry treating apparatus in which an air supply port and an air discharge port are arranged in the width direction of the cabinet, taking into account the hanger body disposed in the front and rear direction of the cabinet. In addition, the present disclosure provides a laundry treating apparatus in which a direction of a circulating flow channel of an air supply is also changed to the width direction of the cabinet based on changes in locations of the air supply port and the air discharge port. In addition, provided is a laundry treating apparatus in which a steam discharge port is located closer to a rear surface of a first chamber than to an inlet. In addition, provided is a laundry treating in which a water supply tank and a drain tank are spaced upwardly apart from a heat exchanger (or a connecting dirt) and are located between an air supply duct and a discharge duct. Further, the present disclosure provides a laundry treating apparatus in which the water supply tank and the drain tank are retractable and extendable via a front surface of the auxiliary chamber.

More specifically, the present disclosure provides a laundry treating apparatus including a cabinet including an inlet defined in a front surface thereof, a door that opens and closes the inlet, a first chamber that is located in the cabinet and accommodates laundry therein via the inlet,
a first chamber bottom surface forming a bottom surface of the first chamber, an auxiliary chamber located separately and beneath the first chamber within the cabinet, a steam supply that is disposed in the auxiliary chamber and supplies steam to the first chamber, an air supply duct that is disposed in the auxiliary chamber, is located close to one side surface among both side surfaces of the cabinet, and sucks air of the first chamber, a discharge duct that is disposed in the auxiliary chamber, is located close to the other side surface among said both side surfaces of the cabinet, and discharges air that has been introduced into the air supply duct to the first chamber, a connecting duct disposed in the auxiliary chamber and connecting the air supply duct with the discharge duct, a tank installation space defined between the connecting duct and the first chamber bottom surface, and a water supply tank that is detachably located in the tank installation space and stores water to be supplied to the steam supply.

The laundry treating apparatus may further include an auxiliary chamber front surface forming a front surface of the auxiliary chamber, and a first accommodating hole extending through the auxiliary chamber front surface, and the water supply tank may be attachable to and detachable from the tank installation space via the first accommodating hole.

The laundry treating apparatus may further include a water supply tank accommodating casing coupled to the auxiliary chamber front surface inside the auxiliary chamber, and the tank installation space may be defined by the water supply tank accommodating casing.

A bottom surface of the water supply tank accommodating casing may be spaced apart from a connecting duct top surface forming a top surface of the connecting duct.

The laundry treating apparatus may further include a water supply pump that supplies water stored in the water supply tank to the steam supply.

The water supply pump may be located between the steam supply and the water supply tank along a height direction of the cabinet.

The water supply pump may be located closer to the inlet than to a rear surface of the first chamber along a front and rear direction of the cabinet.

The steam supply may be located closer to the inlet than to the rear surface of the first chamber along the front and rear direction of the cabinet.

The laundry treating apparatus may further include a water supply pipe connecting the water supply tank with the steam supply, and a water supply connecting portion connecting the water supply pipe with the water supply tank, and the water supply tank may further include a water supply tank body defining a storage space for storing water, a water supply tank body rear surface forming a rear surface of the storage space among surfaces of the water supply tank body, and a water supply valve located on the water supply tank body rear surface and connected to the water supply connecting portion to discharge water stored in the storage space.

The water supply pump may be located closer to the inlet than to a rear surface of the first chamber along a front and rear direction of the cabinet, and at least a portion of the water supply pipe may be disposed along the front and rear direction of the cabinet between the water supply tank and the connecting duct for connection of the water supply connecting portion and the water supply pump.

The water supply tank may include a water supply tank body defining a storage space for storing water, a water supply tank body bottom surface forming a bottom surface of the storage space among surfaces of the water supply tank body, a water supply tank body front surface forming a front surface of the storage space among the surfaces of the water supply tank body, and a water supply tank body rear surface forming a rear surface of the storage space among the surfaces of the water supply tank body, and the water supply tank body bottom surface may be inclined downward from the water supply tank body front surface toward the water supply tank body rear surface.

The water supply tank may further include a water supply tank body top surface forming a top surface of the storage space among the surfaces of the water supply tank body, and a water supply valve located on the water supply tank body rear surface and for supplying water stored in the storage space to the steam supply when the water supply tank is mounted, and the water supply valve may be located closer to the water supply tank body bottom surface than to the water supply tank body top surface.

A length of the water supply tank body along a front and rear direction of the cabinet may be greater than a length of the water supply tank body along a width direction of the cabinet or a height direction of the cabinet.

The laundry treating apparatus may further include a drain tank that is detachably located in the tank installation space and stores condensate condensed in the first chamber.

The laundry treating apparatus may further include an auxiliary chamber front surface forming a front surface of the auxiliary chamber, a first accommodating hole extending through the auxiliary chamber front surface, and a second accommodating hole extending through the auxiliary chamber front surface, the water supply tank may be attachable to and detachable from the tank installation space via the first accommodating hole, and the drain tank may be attachable to and detachable from the tank installation space via the second accommodating hole.

The laundry treating apparatus may further include a water supply tank accommodating casing coupled to the auxiliary chamber front surface inside the auxiliary chamber, and a drain tank accommodating casing coupled to the auxiliary chamber front surface inside the auxiliary chamber, and the tank installation space may be defined by the water supply tank accommodating casing and the drain tank accommodating casing.

A bottom surface of the water supply tank accommodating casing and a bottom surface of the drain tank accommodating casing may be spaced apart from a connecting duct top surface forming a top surface of the connecting duct.

The laundry treating apparatus may further include a water supply pump that supplies water stored in the water supply tank to the steam supply, a heat exchanger that is located inside the connecting duct and exchanges heat with air introduced into the air supply duct, a sump that collects the condensate generated from the heat exchanger and the first chamber, and a drain pump that allows the condensate to flow from the sump to the drain tank.

The laundry treating apparatus may further include a base forming a bottom surface of the auxiliary chamber to support the connecting duct, the air supply duct, the discharge duct, and the steam supply, and the drain pump may be located on the base.

The drain pump may be located closer to the drain tank than to the water supply tank.

The laundry treating apparatus may further include a first chamber rear surface forming a rear surface of the first chamber, and the drain pump may be located closer to the first chamber rear surface than to the inlet along a front and rear direction of the cabinet.

The water supply pump may be located closer to the inlet than to the first chamber rear surface along the front and rear direction of the cabinet.

The sump may be located in an inner lower portion or an outer lower portion of the air supply duct.

The drain tank may include a drain tank body defining a water collection space for storing the condensate, a drain tank body bottom surface forming a bottom surface of the water collection space among surfaces of the drain tank body, a drain tank body front surface forming a front surface of the water collection space among the surfaces of the drain tank body, and a drain tank body rear surface forming a rear surface of the water collection space among the surfaces of the drain tank body, and the drain tank body bottom surface may be inclined downward from the drain tank body front surface toward the drain tank body rear surface.

The laundry treating apparatus may further include a drain pipe connecting the drain tank with the sump, and a drain connecting portion connecting the drain pipe with the drain tank, and the drain tank may further include a drain valve located in the drain tank body rear surface and connected to the drain connecting portion when the drain tank is mounted.

The drain tank may further include a drain tank body top surface forming a top surface of the water collection space among the surfaces of the drain tank body, and the drain valve may be located closer to the drain tank body top surface than to the drain tank body bottom surface.

The drain valve may be located closer to one side surface of the drain tank body than to the other side surface of the drain tank body.

A length of the drain tank body along a front and rear direction of the cabinet may be greater than a length of the drain tank body along a width direction of the cabinet or a height direction of the cabinet.

The water supply tank and the drain tank may be located between the air supply duct and the discharge duct.

In one example, the present disclosure provides a laundry treating apparatus including a cabinet, a first chamber that is located in the cabinet and accommodates laundry therein, a first chamber bottom surface forming a bottom surface of the first chamber, a hanger body that is disposed inside the first chamber, extends along a front and rear direction of the cabinet, and hangs the laundry thereon, an auxiliary chamber located separately and beneath the first chamber within the cabinet, a steam supply that is disposed in the auxiliary chamber and supplies steam to the first chamber, an air supply duct that is located in the auxiliary chamber and sucks air of the first chamber, a discharge duct that is located in the auxiliary chamber and discharges air that has been sucked via the air supply, a connecting duct that is located in the auxiliary chamber, is connecting the air supply duct with the discharge duct, and circulates air along a width direction of the cabinet, a tank installation space defined between the connecting duct and the first chamber bottom surface along a height direction of the cabinet and extending along a front and rear direction of the cabinet, and a water supply tank that is detachably located in the tank installation space and stores water to be supplied to the steam supply.

Additionally, the present disclosure provides for a hanger body that is disposed in a front and rear direction of the cabinet and is extendable forward. In addition, considering user's convenience, the extended hanger body may be constructed to be rotatable, and may be rotated so as to be disposed along a width direction of the cabinet after being extended. Additionally, the present disclosure provides a laundry treating apparatus in which an air supply port and an air discharge port are arranged in the width direction of the cabinet, taking into account the hanger body disposed in the front and rear direction of the cabinet. In addition, the present disclosure provides a laundry treating apparatus in which a direction of a circulating flow channel of an air supply is also changed to the width direction of the cabinet based on changes in locations of the air supply port and the air discharge port. In addition, provided is a laundry treating apparatus in which a steam discharge port is located closer to a rear surface of a first chamber than to an inlet. In addition, provided is a laundry treating in which a water supply tank and a drain tank are spaced upwardly apart from a heat exchanger (or a connecting dirt) and are located between an air supply duct and a discharge duct. Further, the present disclosure provides a laundry treating apparatus in which the water supply tank and the drain tank are retractable and extendable via a front surface of the auxiliary chamber.

More specifically, provided is a laundry treating apparatus including a cabinet including an inlet defined in a front surface thereof, a door that opens and closes the inlet, a first chamber that is located in the cabinet and accommodates laundry therein via the inlet, an auxiliary chamber located separately and beneath the first chamber within the cabinet, a blowing unit that is disposed in the auxiliary chamber and circulates air in the first chamber, an air supply duct that is disposed in the auxiliary chamber, is located close to one side surface among both side surfaces of the cabinet, and allows air of the first chamber to flow to the blowing unit, a connecting duct disposed in the auxiliary chamber and including a heat exchanger for heat exchange between air that has passed through the blowing unit and a refrigerant, and a discharge duct that is disposed in the auxiliary chamber, is located close to the other side surface among said both side surfaces of the cabinet, and allows air that has passed through the connecting duct to flow to the first chamber.

The laundry treating apparatus may further include a compressor that is located inside the auxiliary chamber closer to a rear side of the auxiliary chamber than to the inlet and compresses the refrigerant and circulates the refrigerant via the heat exchanger.

The laundry treating apparatus may further include a hanger body that is disposed inside the first chamber, extends along a front and rear direction of the cabinet, and hangs the laundry thereon.

The laundry treating apparatus may further include an air intake port that extends through the first chamber and allows air in the first chamber to flow to the air supply duct, and an air discharge port that extends through the first chamber and discharges air that has passed through the discharge duct into the first chamber.

The air intake port and the air discharge port may be arranged along a width direction of the cabinet.

Each of the air intake port and the air discharge port may extend in a front and rear direction of the cabinet.

The air supply duct may include an air supply duct body connected to the blowing unit, and an air supply duct guide connecting the air supply duct body with the air intake port.

The air supply duct body may further include an air supply duct inlet connected to the air supply duct guide, and a length of the air supply duct inlet along a front and rear direction of the cabinet may be greater than a length of the air supply duct inlet along a width direction of the cabinet.

The blowing unit may include a blowing fan that sucks air of the first chamber via the air supply duct, a blowing casing including the blowing fan therein, a blowing inlet defined as a portion of one surface of the blowing casing is opened to allow air that has sucked via the air supply duct to flow to the blowing fan, and a blowing vent for allowing air that has passed through the blowing fan to flow to the connecting duct.

A vertical level of the blowing vent may be higher than a vertical level of the blowing inlet.

The laundry treating apparatus may further include a steam supply that is disposed in the auxiliary chamber and supplies steam to the first chamber, and the steam supply may be located downwardly spaced apart from the connecting duct.

The laundry treating apparatus may further include the heat exchanger that is disposed inside the connecting duct and exchanges heat with air sucked by the blowing unit.

The heat exchanger may include a first heat exchanger that cools air sucked by the blowing unit, and a second heat exchanger that heats air that has passed through the first heat exchanger.

The connecting duct may include a duct inlet connecting the connecting duct with the blowing unit, and a duct outlet connecting the connecting duct with the discharge duct.

The duct inlet and the duct outlet may be arranged along a width direction of the cabinet.

The laundry treating apparatus may further include a steam supply that is disposed in the auxiliary chamber and supplies steam to the first chamber, and a steam discharge port that extends through the first chamber to supply steam generated from the steam supply to the first chamber.

The laundry treating apparatus may further include an air intake port that extends through the first chamber and allows air of the first chamber to flow to the air supply duct, and an air discharge port that extends through the first chamber and discharges air that has passed through the discharge duct into the first chamber, and the air intake port and the air discharge port may be arranged along a width direction of the cabinet.

The steam discharge port may be located closer to the air discharge port than to the air intake port.

The steam discharge port may be located at the rear of the air discharge port.

The steam discharge port may extend along a front and rear direction of the cabinet.

The laundry treating apparatus may further include a first chamber rear surface forming a rear surface of the first chamber, and the steam supply may be located closer to the inlet than to the first chamber rear surface.

The steam discharge port may be located closer to the first chamber rear surface than to the inlet.

The laundry treating apparatus may further include a first chamber bottom surface forming a bottom surface of the first chamber, a steam supply that is disposed in the auxiliary chamber and supplies steam to the first chamber, a steam discharge port extending through the first chamber bottom surface to supply steam generated from the steam supply to the first chamber, an air intake port that extends through the first chamber bottom surface and allows air of the first chamber to flow to the air supply duct, and an air discharge port that extends through the first chamber bottom surface and discharges air that has passed through the discharge duct into the first chamber, and the first chamber bottom surface may be inclined downward toward the air intake port.

In the first chamber bottom surface, the air intake port may be located at a vertical level lower than a vertical level of the air discharge port along a width direction of the cabinet.

In the first chamber bottom surface, the air intake port may be located at a vertical level lower than a vertical level of the steam discharge port along a width direction of the cabinet.

The first chamber bottom surface may be inclined downward in a direction toward the inlet.

A portion of the air intake port closer to the inlet than to a rear surface of the cabinet may be located at a vertical level lower than a vertical level of another portion of the air intake port.

The laundry treating apparatus may further include a base forming a bottom surface of the auxiliary chamber, and a supporter coupled to the base and supporting the connecting duct.

The blowing unit may be located between the air supply duct and the supporter.

In one example, the present disclosure provides a laundry treating apparatus including a cabinet, a first chamber that is located in the cabinet and accommodates laundry therein, a hanger body that is disposed inside the first chamber, is extending along a front and rear direction of the cabinet, and hangs the laundry thereon, an auxiliary chamber located separately and beneath the first chamber within the cabinet, an air supply duct that is located in the auxiliary chamber and sucks air of the first chamber, a discharge duct that is located in the auxiliary chamber and discharges air that has been sucked via the air supply duct, and a connecting duct that is located in the auxiliary chamber, is connecting the air supply duct with the discharge duct, and circulates air along a width direction of the cabinet.

### Advantageous Effects

First, the present disclosure may provide the laundry treating apparatus with the space divided into the first chamber that accommodates the laundry or the goods therein and the second chamber that accommodates the laundry or the goods therein separately from the first chamber.

Second, the present disclosure may independently adjust the temperature and the humidity of the first chamber and the temperature and the humidity of the second chamber independently of each other.

Third, the present disclosure may prevent the interference with the adjacent furniture when the door assembly is opened and closed considering the size of the second chamber disposed inside the door assembly.

Fourth, the present disclosure may provide the laundry treating apparatus in which the air circulation direction is set based on the arrangement of the hanger bar where the laundry is hung and the arrangement direction of the hanger bar, taking into account the reduction of the space for accommodating the laundry in the first chamber.

Fifth, the present disclosure may provide the door assembly that may be automatically withdrawn from the cabinet by sensing the opening of the door assembly by the user.

Sixth, the present disclosure may check the laundry or the items accommodated in the second chamber via the front surface of the door assembly.

Seventh, the present disclosure may improve the convenience of the user when hanging the laundry.

Eighth, the present disclosure may uniformly supply air or steam to the laundry hung on the hanger body.

Ninth, the present disclosure may minimize the occurrence of the condensate on the inner surface of the door or the door assembly by changing the arrangement of the steam discharge port.

Tenth, the present disclosure may optimize the arrangement structure of the steam supply, the air supply, and the like and the locations of the water supply tank and the drain tank based on the change in the arrangement of the air discharge port, the air intake port, and the steam discharge port.

### BRIEF DESCRIPTION OF THE DRAWINGS

FIG. 1 shows an example of an existing laundry treating apparatus.

FIG. 2 shows a laundry treating apparatus described in the present disclosure.

FIG. 3 shows a first chamber and a second chamber with a door assembly open.

(a) in FIG. 4 is an example of a mechanical device disposed inside an auxiliary chamber. (b) in FIG. 4 shows an arrangement of a compressor included in a mechanical device.

(a) in FIG. 5 is an example of an opening/closing driver and an inputter/outputter that help open a door assembly. (b) in FIG. 6 schematically shows locations of a first chamber, a second chamber, and an auxiliary chamber inside a cabinet.

(a) in FIG. 6 shows states of an opening/closing driver and a first hinge when a door assembly is closed. (b) in FIG. 6 shows states of an opening/closing driver and a first hinge when a door assembly is opened.

(a) and (b) in FIG. 7 show a problem that occurs when using a hinge coupled to one side surface of a door assembly.

FIG. 8 shows a door of a second chamber being opened with a door assembly open.

FIG. 9 shows a hanger assembly and a shelf coupling portion disposed in a second chamber.

(a) in FIG. 10 is a state of a first hinge when a door assembly is closed. (b) in FIG. 10 shows a state of a first hinge when a door assembly is opened. (c) in FIG. 10 is another example of a first hinge used when opening and closing a door assembly at the other side surface.

FIG. 11 is an example of a second hinge.

(a) in FIG. 12 is a state of a second hinge when a door of a second chamber is closed. (b) in FIG. 12 is a state of a second hinge when a door of a second chamber is opened. (c) in FIG. 12 is an exploded view of a second hinge.

(a) and (b) in FIG. 13 are another example of a laundry treating apparatus described in the present disclosure.

FIG. 14 schematically shows a flow direction of air inside a first chamber.

FIG. 15 is an exploded view of an example of a laundry support.

FIG. 16 shows a hanger body being extended forward of a hanger support.

FIG. 17 is an example of a water supply tank and a drain tank extended forward from an auxiliary chamber.

(a) to (c) in FIG. 18 are for illustrating explaining an inclination of a first chamber bottom surface.

FIG. 19 is an example of a mechanical device assembly EMA disposed inside an auxiliary chamber.

(a) in FIG. 20 is a cross-section of a mechanical device assembly viewed from front. (b) in FIG. 20 is a cross-section of a mechanical device assembly viewed from side.

(a) in FIG. 21 is an example of a mechanical device assembly viewed from front. (b) in FIG. 21 is another example of a mechanical device assembly viewed from front.

FIG. 22 is an example of a mechanical device assembly viewed from another side.

FIG. 23 is an exploded view of an air supply duct, a connecting duct, and a discharge duct located on an air circulating flow channel.

FIG. 24 is an enlarged view of a water supply connecting portion and a drain connecting portion respectively connected to rear sides of a water supply tank and a drain tank.

(a) in FIG. 25 shows an example of a water supply tank. (b) in FIG. 25 shows an example of a drain tank.

(a) in FIG. 26 shows a tank installation space defined between a first chamber bottom surface and a connecting duct top surface. (b) in FIG. 26 shows one cross-section when a water supply tank is accommodated in a water supply tank accommodating casing.

### BEST MODE

Hereinafter, a preferred embodiment of the present disclosure will be described in detail with reference to the accompanying drawings. A configuration of a device or a method for controlling the same to be described below is only for describing an embodiment of the present disclosure, not for limiting the scope of the present disclosure, and reference numerals used the same herein refer to the same components.

Specific terms used herein are only for convenience of description and are not used as a limitation of the illustrated embodiment.

For example, expressions indicating that things are in the same state, such as “same”, “equal”, “homogeneous”, and the like, not only indicate strictly the same state, but also indicate a state in which a tolerance or a difference in a degree to which the same function is obtained exists.

For example, expressions indicating a relative or absolute arrangement such as “in a certain direction”, “along a certain direction”, “parallel”, “orthogonal”, “central”, “concentric”, “coaxial”, or the like not only strictly indicate such arrangement, but also indicate a state in which a relative displacement is achieved with a tolerance, or an angle or a distance that achieves the same function.

In order to describe the present disclosure, the description below will be achieved on the basis of a spatial orthogonal coordinate system with an X-axis, a Y-axis, and a Z-axis orthogonal to each other. Each axial direction (an X-axis direction, a Y-axis direction, or a Z-axis direction) means both directions in which each axis extends. Adding a ‘+’ sign in front of each axial direction (a +X-axis direction, a +Y-axis direction, or a +Z-axis direction) means a positive direction, which is one of the two directions in which each axis extends. Adding a ‘−’ sign in front of each axial direction (a −X-axis direction, a −Y-axis direction, or a −Z-axis direction) means a negative direction, which is the other of the two directions in which each axis extends.

Expressions referring to directions such as “front (+Y)/rear (−Y)/left (+X)/right (−X)/up (+Z)/down (−Z)” to be mentioned below are defined based on a XYZ coordinate axis. However, this is to describe the present disclosure such that the present disclosure may be clearly understood. In one example, each direction may be defined differently depending on the standard.

The use of terms such as ‘first, second, third’ in front of the components to be mentioned below is only to avoid confusion of the components referred to, and is independent of the order, importance, or master-slave relationship between the components. For example, an invention including only the second component without the first component may also be implemented.

As used herein, singular expressions include plural expressions unless the context clearly dictates otherwise.

As used herein, laundry includes not only tops such as a dress shirt and a blouse, but also bottoms such as jeans. In addition, it is a concept that includes all laundry that requires daily care, such as a suit, a jumper, leather clothes, and the like. Therefore, it may include uniforms such as a school uniform or a company uniform. In addition, as used herein, a term ‘goods’ has been used as a term including items such as a hat, a scarf, a handkerchief, a bag, or a doll, excluding typical laundry, and also including things such as a watch and an accessory. However, herein, even when only one of the terms ‘laundry’ and ‘goods’ is used, such term may be interpreted to include both the laundry and the goods in the context of the present document. In other words, the two are not used to exclude each other, but to include each other.

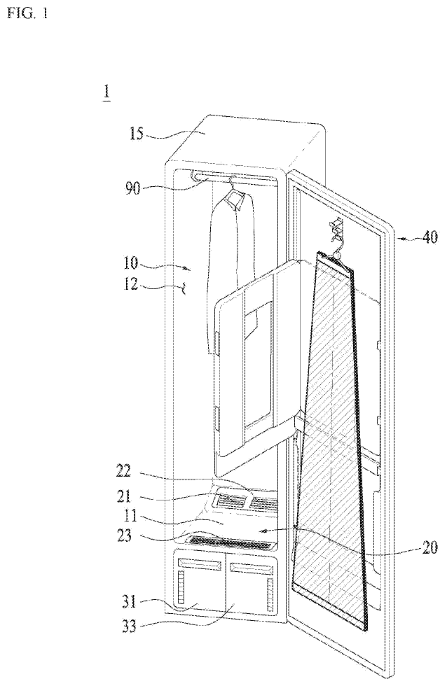

FIG. 1 shows an example of an existing laundry treating apparatus 1. The laundry treating apparatus 1 includes a cabinet 15 including an inlet 12 defined in one surface thereof, a first chamber 10 located inside the cabinet 15 to accommodate the laundry therein through the inlet 12, an auxiliary chamber 20 located under the first chamber 10 and defining therein a space separated from the first chamber 10, a steam unit (not shown) disposed inside the auxiliary chamber 20 to generate steam and supply the steam to the first chamber 10, and a door 40 pivotably coupled to the cabinet 15 to open and close the inlet 12. Considering a usage method of general users, the inlet 12 will preferably be defined in a front surface of the cabinet 15.

In addition, the laundry treating apparatus 1 may further include a blowing unit (not shown) that is located inside the auxiliary chamber 20 and sucks air from the first chamber 10, and a heat pump unit (not shown) that dehumidifies and heats the sucked air and then discharges the air to the first chamber 10.

The cabinet 15 may be made of a metal material, but may also be made of a plastic material as long as it may maintain strength. Additionally, the first chamber 10 may be formed by an inner casing manufactured by plastic injection molding. The first chamber 10 may be coupled to the cabinet 15 by a frame (not shown).

The laundry that requires the care may be placed in the first chamber 10, and the laundry may be cared for in a refreshing way via the blowing unit (not shown), the heat pump unit (not shown), and the steam unit (not shown) located inside the auxiliary chamber 20. That is, a function of sterilizing and deodorizing the laundry and removing wrinkles formed by use may be performed using steam and/or heated air via the blowing unit (not shown), the heat pump unit (not shown), and the steam unit (not shown) located inside the auxiliary chamber 20.

The first chamber 10 may include a laundry support 90 for hanging the laundry at an inner upper portion of the first chamber 10. The laundry support 90 may accommodate thereon a hanger where the laundry is hung, and may be connected to a driver (not shown) that may reciprocate the laundry support part 90 in a left and right direction. The movement of the laundry support 90 may shake the laundry, ultimately removing foreign substances, including fine dust, attached to the laundry. Additionally, while shaking the laundry mounted on the laundry support 90, the wrinkles in the laundry may be removed to some extent by being exposed to steam or moisture supplied from the auxiliary chamber 20.

That is, the laundry support 90 may allow the laundry to be hung in an unfolded state by a self-weight thereof inside the first chamber 10, so that the laundry may be evenly exposed to dehumidified and heated air and/or steam supplied from the auxiliary chamber 20.

An air supply port 21 and a steam supply port 22 for supplying steam generated by the steam unit (not shown) and air dehumidified and heated by the heat pump unit (not shown) inside the auxiliary chamber 20 to the first chamber 10, and an air intake port 23 for sucking air from the first chamber 10 by the blowing unit (not shown) may be located on a first chamber bottom surface 11.

As shown in FIG. 1, the air supply port 21 and the steam supply port 22 may be disposed on the first chamber bottom surface 11 or on a first chamber rear surface (not shown). In addition, an area where the first chamber bottom surface 11 and the first chamber rear surface (not shown) meet each other may be formed in a smoothly inclined shape, and the air supply port 21 and the steam supply port 22 may be disposed on the inclined surface.

The air intake port 23 may be located close to the inlet 12 on the first chamber bottom surface 11. Accordingly, the air supply port 21 and the air intake port 23 are arranged along a front and rear direction of the cabinet 15. On the other hand, the laundry support 90 extends along a width direction of the cabinet 15. This is to ensure that air discharged from the air supply port 21 is uniformly supplied to the laundry hanging on the laundry support 90.

Air inside the first chamber 10 will circulate by being discharged through the air supply port 21 and sucked via the air intake port 23. A water supply tank 31 and a drain tank 33 may be constructed to be independently detachable from a tank module frame (not shown). Otherwise, the water supply tank 31 and the drain tank 33 may be coupled into one and detachable at the same time.

As described above, the existing laundry treating apparatus 1 is an apparatus only for the laundry care and utility thereof as an apparatus for storage or display, including the laundry care, is not high. In addition, the existing laundry treating apparatus does not have a separate space for a case in which an amount of laundry or goods is small, so that input electrical energy may not be utilized efficiently.

In a case of expensive laundry or items, care via temperature and humidity adjustment, as well as display are required. Herein, reflecting such need, it is disclosed that the laundry treating apparatus has a space at a front side that is separate from the first chamber 10 and is able to independently adjust the temperature and the humidity.

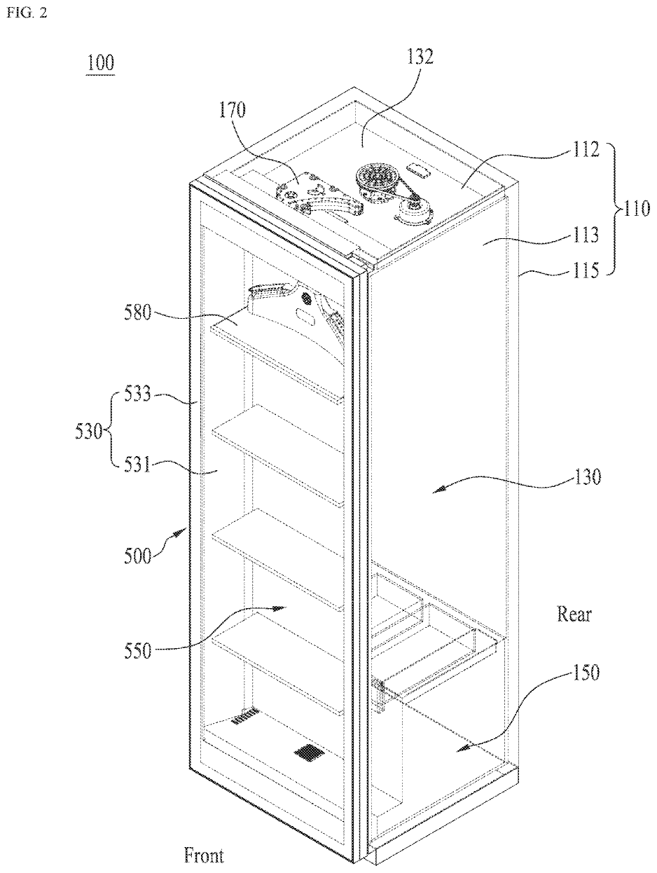

FIG. 2 shows a laundry treating apparatus 100 described in the present disclosure. Referring to FIG. 2, the laundry treating apparatus 100 includes a cabinet 110 including a first inlet 131 defined in a front surface thereof, a first chamber 130 located inside the cabinet 110 to accommodate the laundry or the goods therein through the first inlet 131, an auxiliary chamber 150 located inside the cabinet 110 at a lower side of the cabinet 110 and defining therein a space separated from the first chamber 130, a door assembly 500 that opens and closes the first inlet 131, and a second chamber 550 that is located inside the door assembly 500, defines therein a space separated from the first chamber 130 and the auxiliary chamber 150, and accommodates the laundry or the goods therein.

Because the first chamber 130 is a space that treats the laundry of the items accommodated, the first chamber 130 may be referred to as a treatment chamber.

The cabinet 110 may include a cabinet top surface 112 that forms a top surface of the cabinet 110, a cabinet rear surface 115 that forms a rear surface of the cabinet 110, and a cabinet left side surface 113 and a cabinet right side surface (not shown) that form both side surfaces of the cabinet. The cabinet left side surface 113 and the cabinet right side surface (not shown) will be disposed to face each other. The cabinet top surface 112, the cabinet left side surface 113, and the cabinet right side surface 114 may be integrally formed.

The cabinet 110 includes the first inlet 131 in the front surface thereof. Therefore, the first chamber 130 is accessible via the first inlet 131. The cabinet 110 may further include the first chamber 130 and the auxiliary chamber 150 located under the first chamber 130 inside the cabinet 110.

The first chamber 130 may include a first area 1301 (see (b) in FIG. 5) located on the auxiliary chamber 150, and a second area 1302 (see (b) in FIG. 5) located in front of the auxiliary chamber 150 and where at least a portion of the second chamber 550 is accommodated when the door assembly 500 closes the first inlet 131.

The first chamber 130 may be a space where the laundry is accommodated and cared for. The first chamber 130 may also be called a treatment room. The auxiliary chamber 150 may be a space where an electrical device or a mechanical device for supplying hot air or steam to the first chamber 130 is installed. The auxiliary chamber 150 may also be called a machinery room. The second chamber 550, as a space separate from the first chamber 130 and the auxiliary chamber 150, may also be called an auxiliary care room, a showcase room, or a display room.

When the door assembly 500 closes the first inlet 131, at least a portion of the second chamber 550 is located inside the first chamber 130, so that the second chamber 550 may be located in front of the auxiliary chamber 150.

The door assembly 500 may serve as a door that opens and closes the first inlet 131. A user will need to open and close the door assembly 500 to access the first chamber 130.

Additionally, the door assembly 500 may include the second chamber 550 therein for caring for, displaying, and storing the laundry or the goods. That is, the door assembly 500 may simultaneously perform the role of the door that opens and closes the first inlet 131, as well as the role of the space for caring for, storing, and displaying the laundry or the goods accommodated therein.

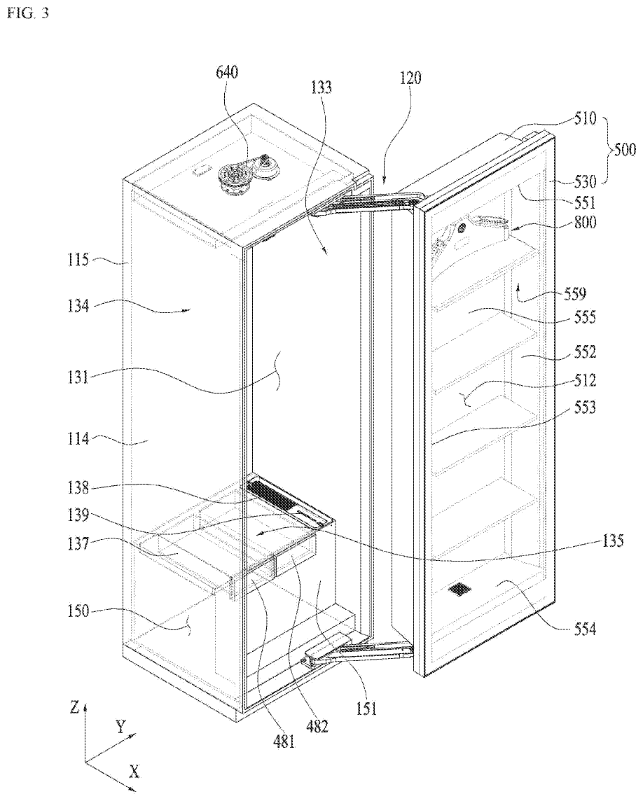

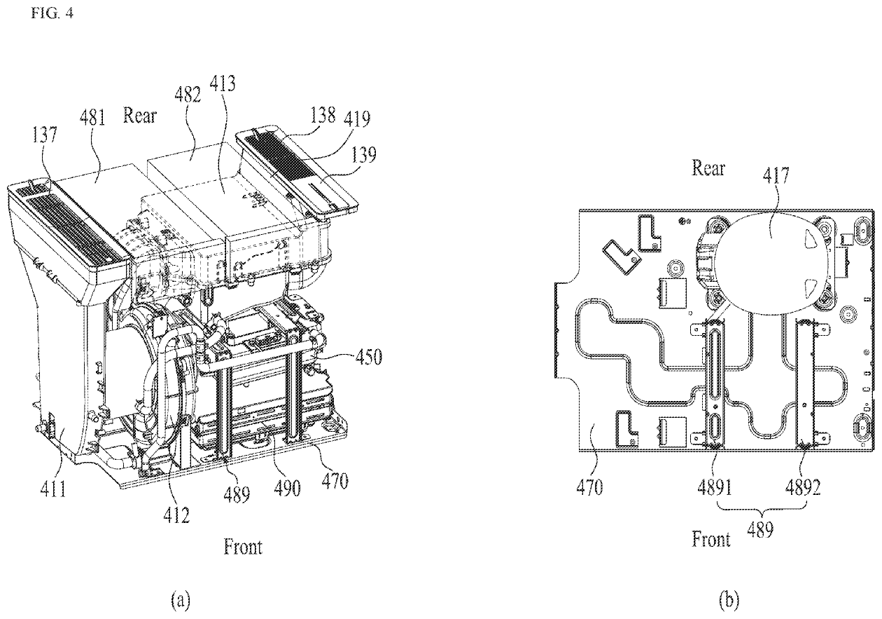

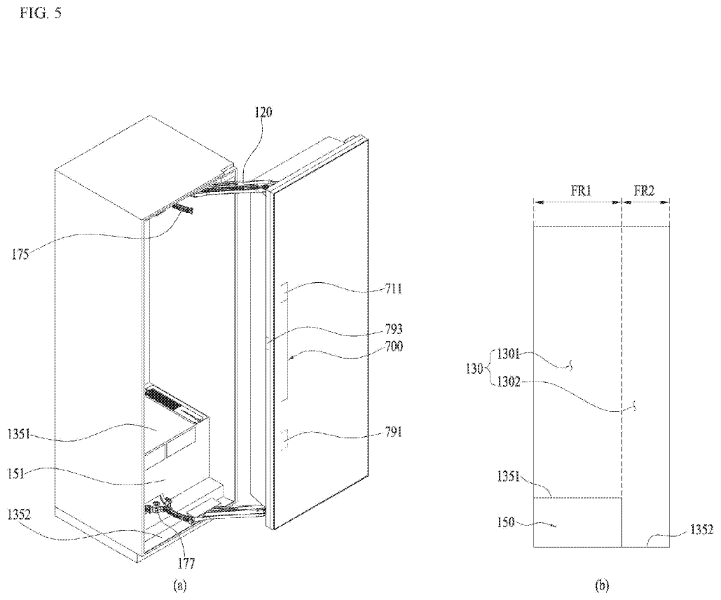

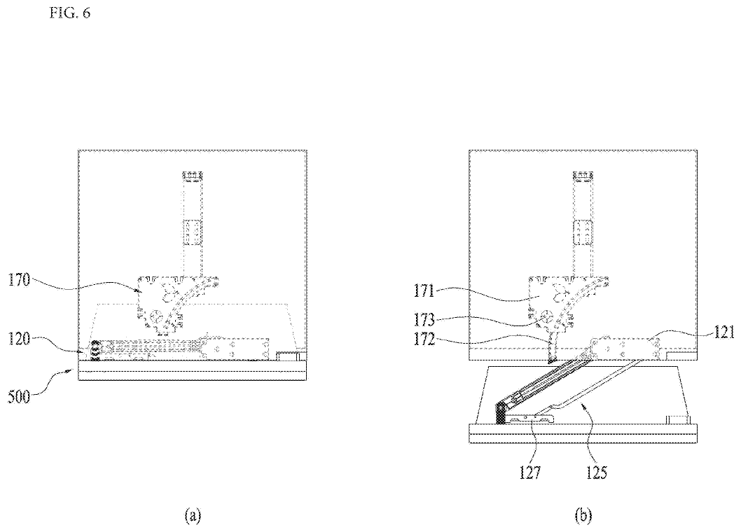

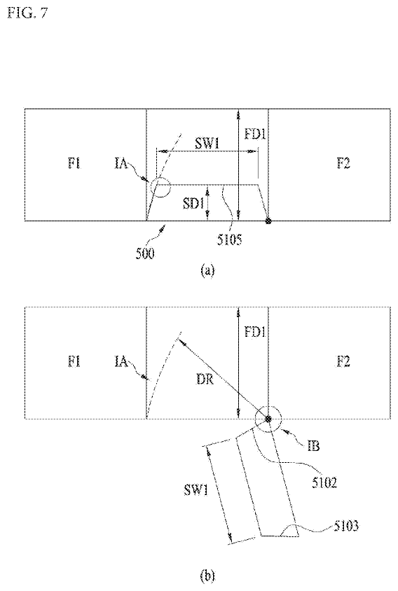

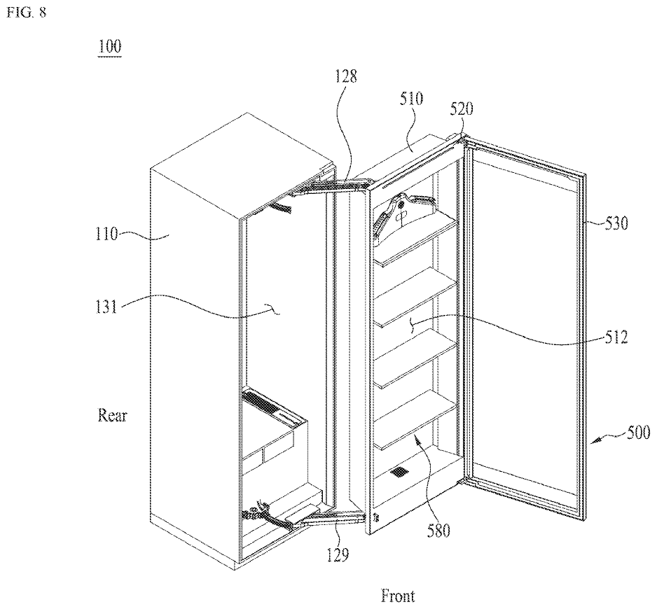

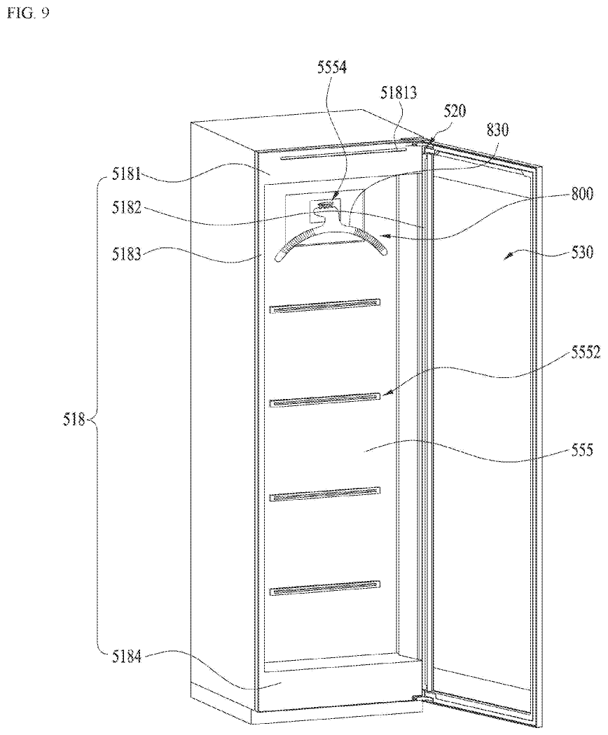

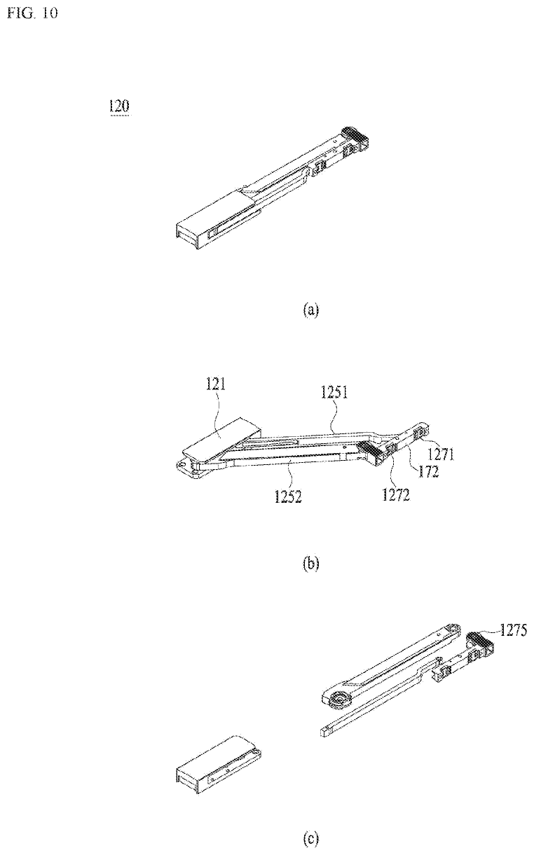

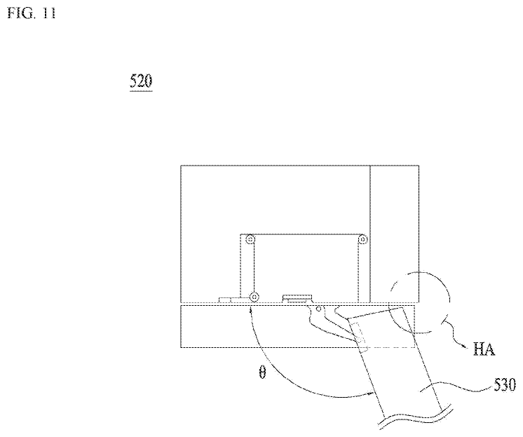

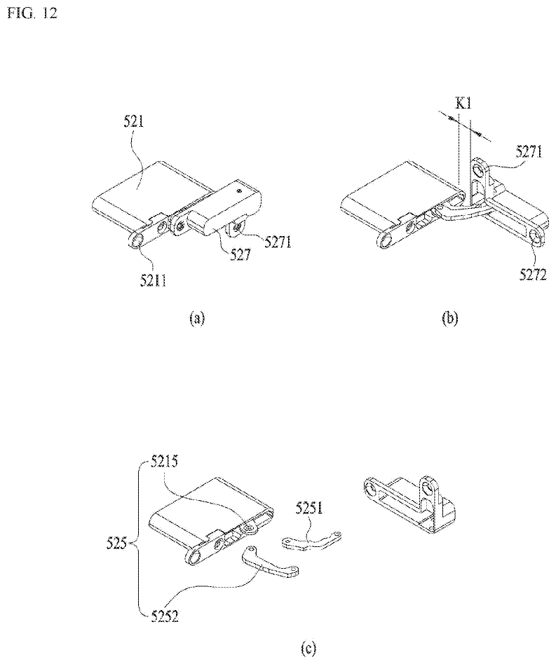

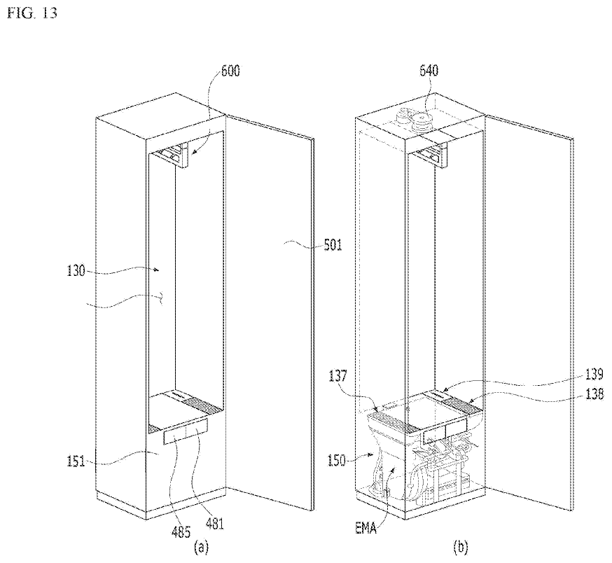

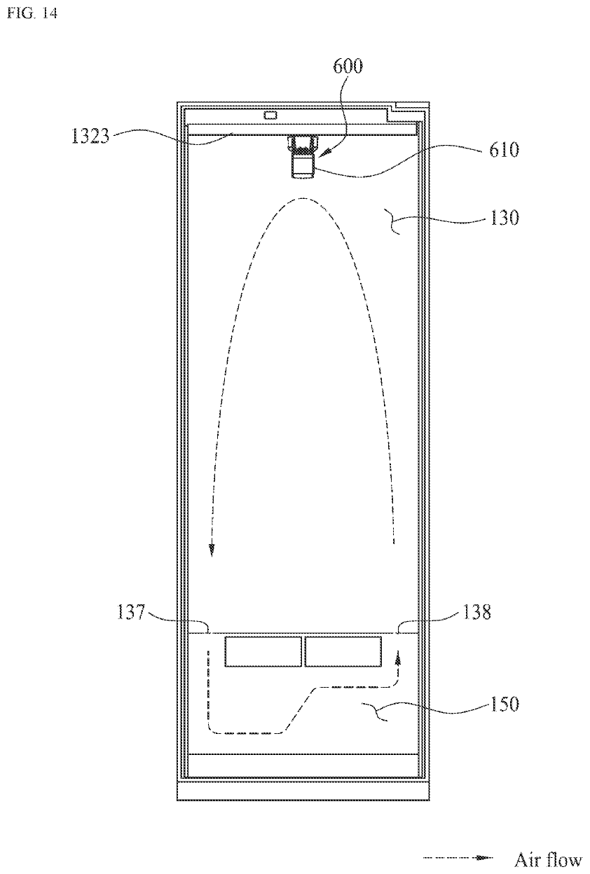

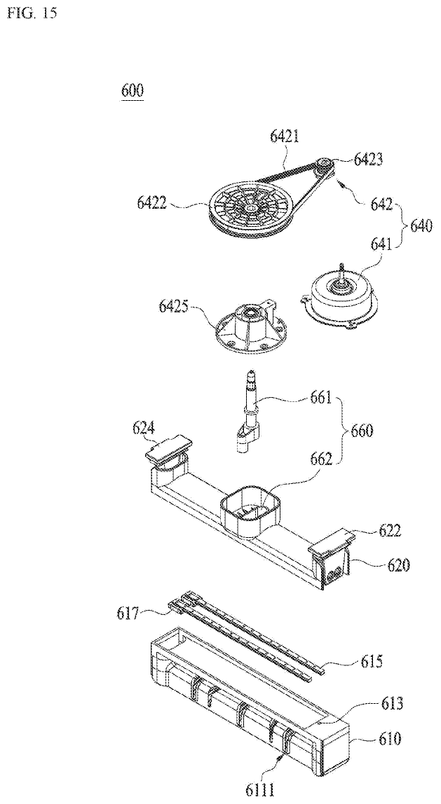

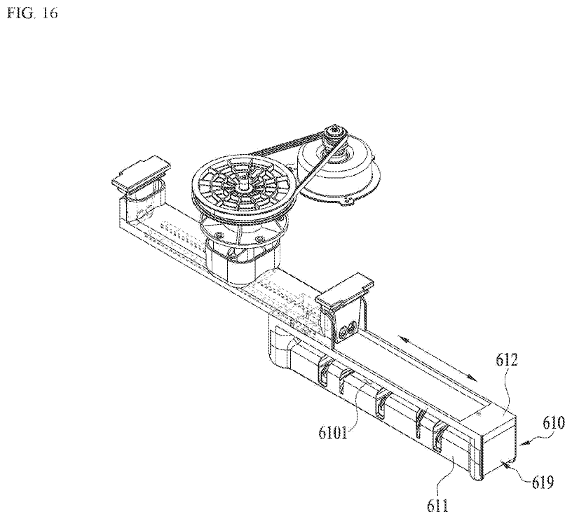

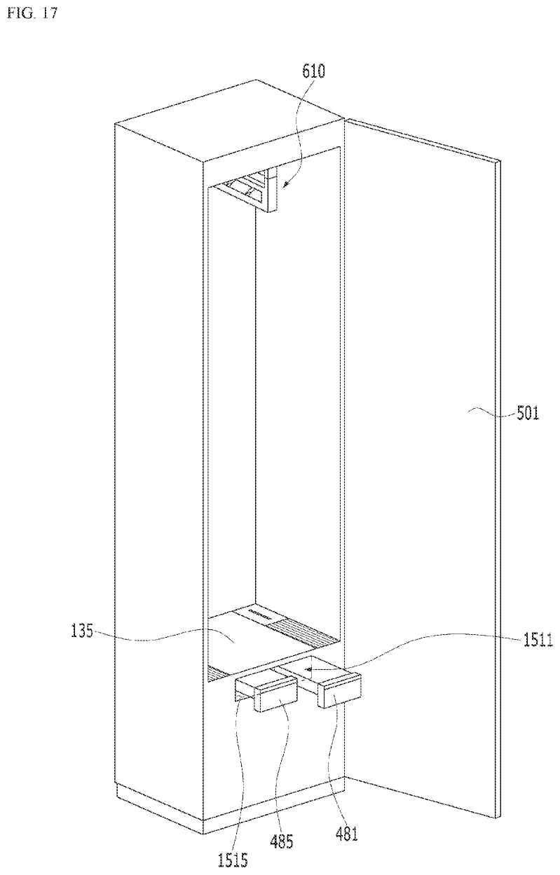

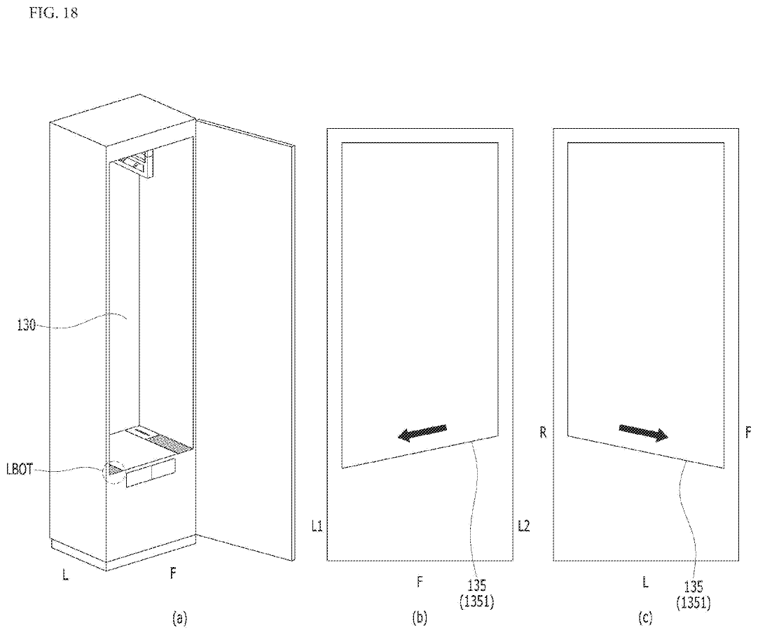

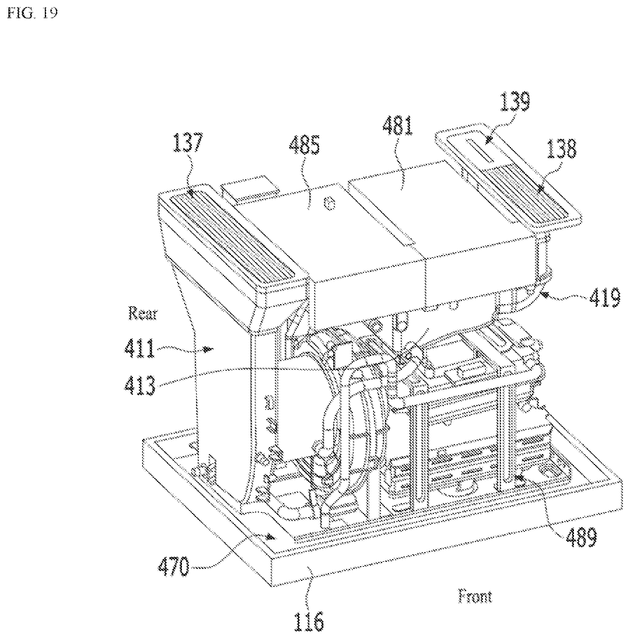

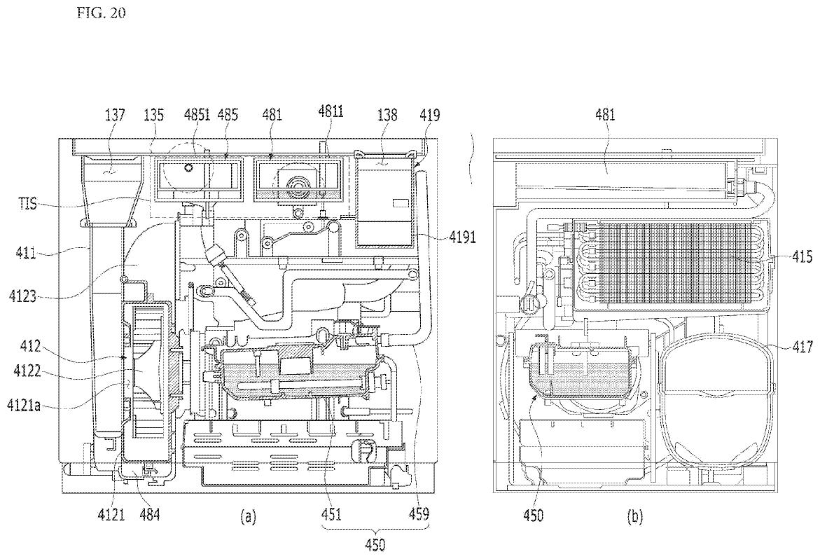

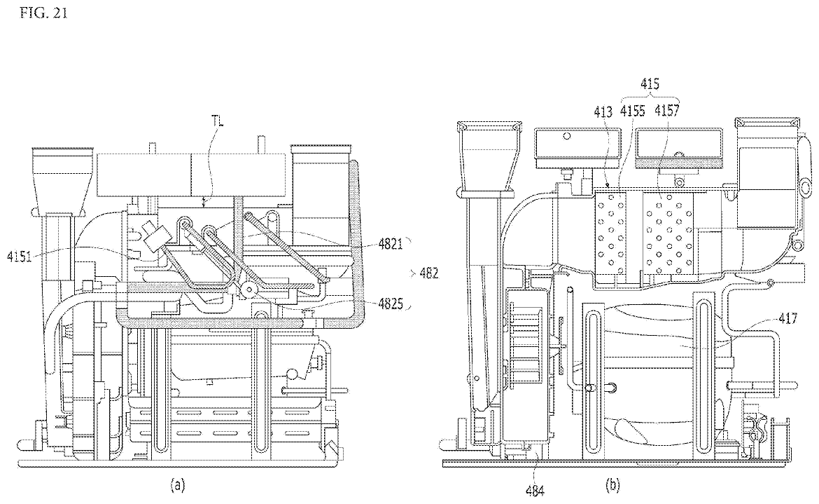

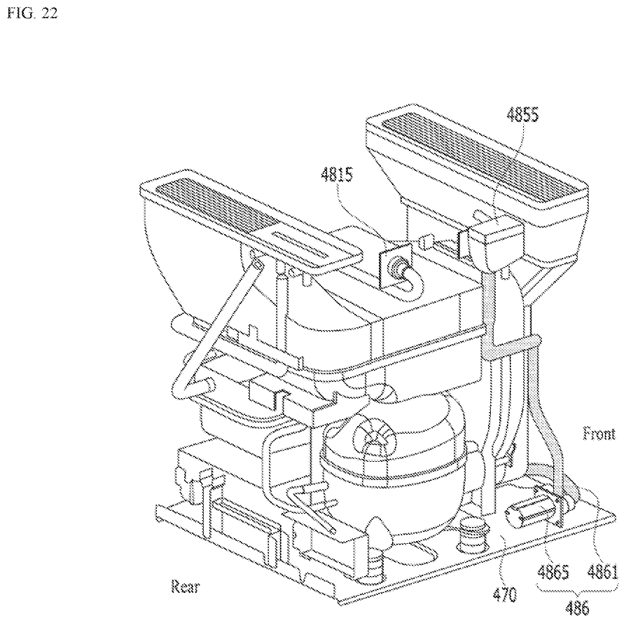

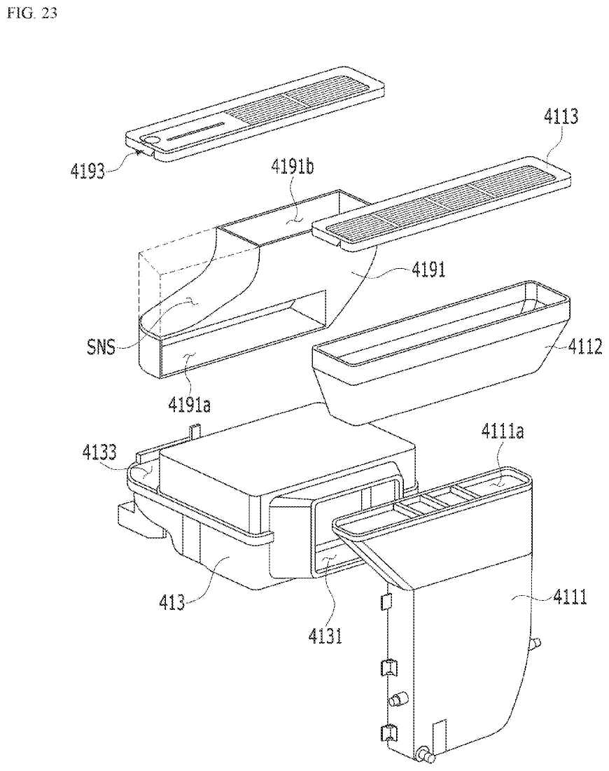

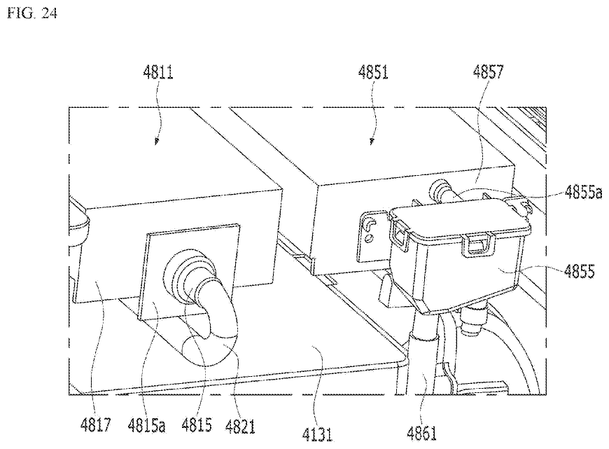

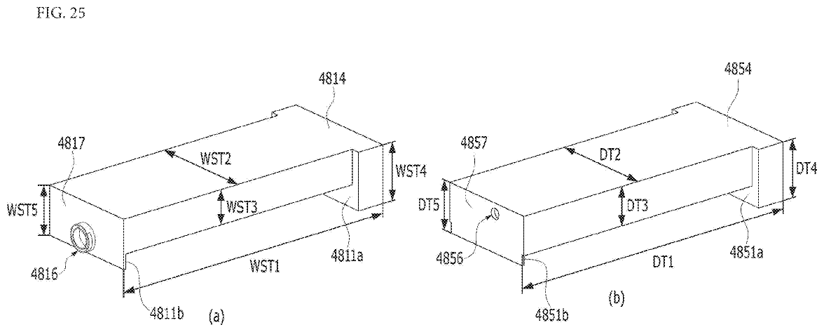

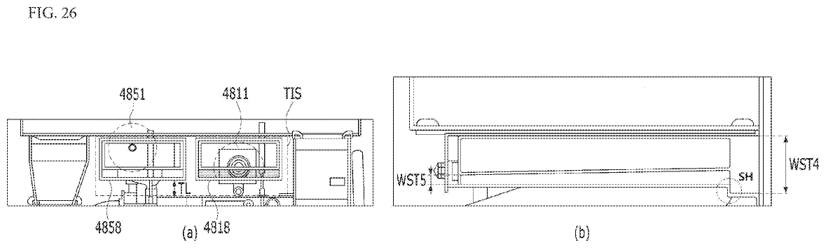

The door assembly 500 may include a second inlet 512 (see FIG. 3) in a front surface thereof, an accommodating body 510 (see FIG. 3) forming the second chamber 550 therein, and a door 530 of the second chamber that opens and closes the second inlet 512. After opening the door 530 of the second chamber, the user may put the laundry or the goods in the second chamber 550 through the second inlet 512.

Considering that, when the door assembly 500 closes the first inlet 131, at least a portion of the second chamber 550 is located in the second area 1302, which is located closer to the first inlet 131 than a rear surface of the first chamber 130 inside the first chamber 130, at least a portion of the receiving body 510 will be located in the second area 1302 when the door assembly 500 closes the first inlet 131.

At least a portion of the second chamber 550 may be accommodated in a space between the first inlet 131 and the auxiliary chamber 150 when the door assembly 500 closes the first inlet 131.

Accordingly, when the door assembly 500 closes the first inlet 131, the second chamber 550 may be located in front of the auxiliary chamber 150 inside the first chamber 130. Accordingly, the auxiliary chamber 150 may be positioned at a predetermined distance rearward from the first inlet 131 to accommodate at least a portion of the door assembly 500 inside the first chamber 130.

In one example, the first inlet 131 may be opened and closed with a door with no separate internal space, unlike the door assembly 500 including the second chamber 550 inside.

As shown in FIG. 2, a bottom surface of the first chamber 130 may be formed to be stepped because of the auxiliary chamber 150 forming the bottom surface.

In one example, the door assembly 500 may mount a laundry hanger 830 (see FIG. 9) for accommodating the laundry in the second chamber 550. Alternatively, a shelf 580 that is detachably disposed in the second chamber 550 to support the laundry or the goods accommodated in the second chamber 550 may be further included.

As shown in FIG. 2, the door 530 of the second chamber may be made of a material that allows the interior of the second chamber 550 to be viewed. In other words, at least a portion of the door 530 of the second chamber may be made of a material that allows visible light to pass through.

When the door 530 of the second chamber is opened, the door assembly 500 may accommodate the laundry or the items in the second chamber 550 through the second inlet 512.

Accordingly, a front surface of the door 530 of the second chamber may be made of a transparent material. It may be made of a completely transparent material, but on the other hand, may also be made of a translucent material.

To this end, the door 530 of the second chamber may include an opening (not shown) in which at least a portion of a front surface is opened, and may include a door frame 533 of the second chamber forming a frame of the door 530 of the second chamber and a door window 531 of the second chamber surrounded by the door frame 533 of the second chamber and coupled to the door frame 533 of the second chamber.

At least a portion of the door window 531 of the second chamber may be made of the transparent material or may be made of the translucent material. Additionally, the door window 531 of the second chamber may be transparent but may have a color.

The door frame 533 of the second chamber may be disposed to surround an outer surface of the door window 531 of the second chamber. In contrast, the door frame 533 of the second chamber may be coupled to a rear surface of the door window 531 of the second chamber, so that only the door window 531 of the second chamber may be exposed in a forward direction of the door 530 of the second chamber.

In one example, the laundry treating apparatus 100 may further include an opening/closing driver 170 that pushes the door assembly 500 to automatically open the door assembly 500. The opening/closing driver 170 may be disposed between the cabinet top surface 112 and a first chamber top surface 132 forming a top surface of the first chamber 130.

Referring to FIG. 2, the opening/closing driver 170 may be coupled to a lower side of the cabinet top surface 112. Alternatively, the opening/closing driver 170 may be disposed at the lower side of the first chamber top surface 132.

One opening/closing driver 170 may be sufficient, but there may be a plurality of opening/closing drivers. The opening/closing driver 170 may be disposed not only between the cabinet top surface 112 and the first chamber top surface 132, but also on a first chamber bottom surface 135 forming a bottom surface of the first chamber. Alternatively, the opening/closing driver 170 may be located between the first chamber bottom surface 135 and a bottom surface of the cabinet 110.

The reason why there are the plurality of opening/closing drivers 170 is to prevent deformation of the door assembly 500 or a hinge structure that couples the door assembly 500 to the cabinet from occurring as the door assembly 500 is pushed from above or below and thus a force is concentrated on one side or unnecessary torque is generated.

Referring to FIG. 3, the door assembly 500 may further include an accommodating housing 559 located inside the accommodating body 510 to form the second chamber 550.

When the accommodating body 510 corresponds to an outer body, the accommodating housing 559 may correspond to an inner body. Ultimately, the accommodating housing 559 may form an inner surface of the second chamber 550.

A predetermined empty space may be defined between the accommodating body 510 and the accommodating housing 559, and a mechanical device for conditioning air in the second chamber 550 or various wires may be installed in the empty space.

Accordingly, the door assembly 500 may include the second inlet 512 at the front surface thereof and the accommodating housing 559 forming the second chamber 550 inside the accommodating body 510.

The accommodating housing 559 may include a second chamber top surface 551 (see FIG. 19) forming an upper portion of the second chamber 550, a second chamber bottom surface 554 forming a bottom surface of the second chamber 550, a second chamber rear surface 555 forming a rear surface of the second chamber and connecting a rear edge of the second chamber top surface 551 with a rear edge of the second chamber bottom surface 554, and a second chamber left side surface 552 and a second chamber right side surface 553 connecting the second chamber top surface 551, the second chamber bottom surface 554, and the second chamber rear surface 555 with each other.

In one example, the laundry treating apparatus 100 may sterilize, deodorize, remove the wrinkles from, and dry the laundry by spraying hot air or steam to the laundry accommodated in the first chamber 130. In particular, insulation of the laundry treating apparatus 100 may be important for the drying and the steam spraying.

In particular, this is because an overall insulation performance may be deteriorated when there is no insulating material because at least the portion of the door 530 of the second chamber is made of the material that allows visible light to pass therethrough. Additionally, there may be a risk of burns when the user unintentionally touches the door with hand during the steam spraying or the drying. To prevent this, the second chamber 550 should be formed separately from the first chamber 130 and the auxiliary chamber 150. In particular, in the door assembly 500, an insulating layer using the insulating material or air may be formed in the empty space between the accommodating body 510 and the accommodating housing 559.

In one example, the laundry treating apparatus 100 may further include a laundry driver 640 located between the first chamber top surface 132 and the cabinet top surface 112 to reciprocate a hanger body 610 (see FIG. 13), which will be described later. This is to protect the laundry driver 640 from hot air, steam, or moisture supplied to the first chamber 130 and to prevent a complex driving device or the like such as the laundry driver 640 from being exposed to the user.

In one example, the laundry treating apparatus 100 may further include a first hinge 120 that pivots such that, when the door assembly 500 is opened, the door assembly 500 is withdrawn forward of the cabinet 110 and then moves along a width direction of the cabinet 110, and a second hinge 520 (see FIG. 8) that pivots to open the second inlet 512 via the pivoting of the door 530 of the second chamber when the door 530 of the second chamber is opened.

When the door assembly 500 closes the first inlet 131, the door assembly 500 will move in a reverse order of opening the door assembly 500.

The first hinge 120 may move the door assembly 500 while maintaining an angle between the door assembly 500 and the first inlet 131. That is, when the door assembly 500 moves, the first hinge 120 will allow the second inlet 512 to always face forward.

In other words, when the door assembly 500 is moved, an angle formed by the door assembly 500 with a front surface of the cabinet will be maintained. To this end, the first hinge 120 may separate the door assembly 500 from the first chamber 130 and then move the same along the width direction of the cabinet 110 to open the first inlet 131.

Considering an usage pattern of the users, the laundry treating apparatus 100 may not be installed in an isolated manner, but may be installed and used indoors as of a built-in type. Accordingly, a size of the laundry treating apparatus 100 may be determined by considering a standard size of a closet or furniture installed adjacent thereto.

Accordingly, while the external size of the laundry treating apparatus 100 remains the same, a size of the door assembly 500 including the second chamber 550 increases, so that a volume of the first chamber 130 may decrease. Additionally, to prevent interference with the adjacent furniture when opening and closing the door assembly 500, it is preferable that a portion of the accommodating body 510 is inserted into and accommodated inside the first chamber 130.

To this end, to prevent the interference between the first chamber 130 and the furniture adjacent to the laundry treating apparatus 100, the first hinge 120 may open and close the door assembly 500 as described above.

On the other hand, the second hinge 520, which will be described later, will open the second inlet 512 by moving the door 530 of the second chamber such that an angle between the door 530 of the second chamber and the front surface of the accommodating body 510 increases.

That is, similar to a hinge of a general door, the angle between the door 530 of the second chamber and the second inlet 512 may change while opening and closing the door 530 of the second chamber.

FIG. 3 shows the interior of the first chamber 130 with the door assembly 500 open. Additionally, the interior of the second chamber 550 with the door 530 of the second chamber made of the transparent or translucent material closed is shown.

Referring to FIG. 3, the first chamber 130 may be formed by the first chamber top surface 132 (see FIG. 2) forming the top surface of the first chamber 130, the first chamber bottom surface 135 forming the bottom surface of the first chamber 130, and a first chamber left side surface 133, a first chamber right side surface 134, and a first chamber rear surface 136 connecting the first chamber top surface 132 with the first chamber bottom surface 135 to form both side surfaces and a rear surface, respectively.

The first chamber 130 may be made of a plastic or metal material. In the case of plastic material, the first chamber 130 may be formed via injection molding.

The auxiliary chamber 150 may be disposed to be separated from the first chamber 130 at an inner lower portion of the cabinet 110. The electrical or mechanical devices necessary for spraying hot air and/or steam into the first chamber 130 may be disposed in the auxiliary chamber 150. Considering that operation of the mechanical device causes vibration or noise and considering weights of the various mechanical devices, it is preferable that the auxiliary chamber 150 is located under the first chamber 130.

In a case of the typical laundry treating apparatus 1, the first chamber bottom surface 135 may be formed extend to the first inlet 131 and the auxiliary chamber 150 may be located beneath an entirety of the first chamber bottom surface 135. However, in the present disclosure, considering that the door assembly 500 is inserted into the first chamber 130, it may be preferable for the auxiliary chamber 150 to be formed in a lower portion of the first chamber 130.

Accordingly, an auxiliary chamber front surface 151, which is a front surface of the auxiliary chamber 150 facing the door assembly 500, will be located at the rear of the first inlet 131. This may mean that a step height is formed on the first chamber bottom surface 135 in a side view of the first chamber 130.

On the other hand, in another example, the second chamber 550 may be located upward of the auxiliary chamber 150 between the first inlet 131 and the auxiliary chamber 150. However, in this case, when the door assembly 500 is closed, the second chamber 550 will protrude into the first chamber 130.

In addition, in the case of another example, because the second chamber 550 is located upward of the auxiliary chamber 150, there is no interference between the auxiliary chamber 150 and the second chamber 550, so that the first chamber bottom surface 135 may not have the step height.

That is, when the door assembly 500 is inserted into the first chamber 130, a lower portion of the accommodating body 510 will face the auxiliary chamber front surface 151 and an upper portion of the accommodating body 510 will face the first chamber rear surface 136. That is, when the door assembly 500 closes the first inlet 131, the second chamber 550 will be located in front of the auxiliary chamber 150 inside the first chamber 130.

Therefore, a length of a rear surface of the accommodating body 510 inserted into the first chamber 130 is greater than a vertical length from the first chamber top surface 132 to the first chamber bottom surface 135 along a height direction of the cabinet 110 and is smaller than a vertical length from the first chamber top surface 132 to the first chamber bottom surface 135.

Accordingly, the first chamber bottom surface 135 may be formed to be stepped. Referring to (a) in FIG. 5, the first chamber bottom surface 135 may include a first bottom surface 1351 and a second bottom surface 1352 disposed at different vertical levels.

Referring to FIG. 3 and (a) in FIG. 4, the first chamber bottom surface 135 may include an air intake port 137 and an air discharge port 138 in communication with an air supply 410 that circulates or heats air of the first chamber 130. In addition, the first chamber bottom surface 135 may further include a steam discharge port 139 that is in communication with a steam supply 450 that generates steam and supplies the steam to the first chamber 130.

The auxiliary chamber 150 may be located beneath the first bottom surface 1351. Accordingly, the air intake port 137, the air discharge port 138, and the steam discharge port 139 may be located on the first bottom surface 1351 rather than on the second bottom surface 1352.

Additionally, a length from the first chamber top surface 132 to the first bottom surface 1351 may be smaller than a length from the first chamber top surface 132 to the second bottom surface 1352.

Referring to FIG. 3, the air intake port 137 and the air discharge port 138 may be arranged to be spaced apart from each other along the width direction or a left and right direction of the cabinet 110.

One of the air intake port 137 and the air discharge port 138 may be located close to one side surface of the two side surfaces 113 and 114 of the cabinet 110, and the other of the air intake port 137 and the air discharge port 138 may be located close to the other side surface of the two side surfaces 113 and 114 of the cabinet 110.

Additionally, the steam discharge port 139 may be located closer to the air discharge port 138 than the air intake port 137.

In one example, FIG. 3 and (a) in FIG. 4 show an example in which the steam discharge port 139 is located close to the first inlet 131. That is, the steam discharge port 139 may be located forwardly of the air discharge port 138. However, this is only an example, and it may be desirable for the steam discharge port 139 to be located closer to the first inlet 131 than to the air discharge port 138 in terms of condensate treatment. This is to minimize the condensation generated on the first chamber rear surface 136.

A length in the front and rear direction of the second bottom surface 1352 may be set considering a depth at which the portion of the door assembly 500 is inserted into the first inlet 131.

For example, the depth at which the door assembly 500 is inserted into the first inlet 131 may be equal to or greater than ⅙ and equal to or smaller than ½ of a length in the front and rear direction of the cabinet 110. This is because the depth at which the door assembly 500 is inserted into the first inlet 131 should be ⅙ or greater considering a size of the goods accommodated in the second chamber 550, and it is preferable that the depth at which the door assembly 500 is inserted into the first inlet 131 is equal to or smaller than ½ for preventing overturning of the cabinet 110 considering a weight of the door assembly 500.

A water supply tank 481 for supplying water for the steam generation and a drain tank 485 for storing condensate may be inserted into the auxiliary chamber 150 through the auxiliary chamber front surface 151. That is, the auxiliary chamber front surface 151 may include a water supply tank insertion hole (not shown) and a drain tank insertion hole (not shown) into which the water supply tank 481 and the drain tank 485 are inserted, respectively, and the water supply tank 481 and the drain tank 485 may be inserted into or separated from the auxiliary chamber 150 via the water supply tank insertion hole and the drain tank insertion hole.

Referring to FIG. 3, the water supply tank 481 and the drain tank 485 may be positioned spaced apart from each other. That is, a space where the water supply tank 481 is installed and a space where the drain tank 485 is installed may be separated from each other. In a case of the typical laundry treating apparatus, they are located adjacent to each other in one tank installation space, so that the user may have difficulty in removing only one of the water supply tank 481 and the drain tank 485. To prevent this, in the laundry treating apparatus 100, the water supply tank 481 and the drain tank 485 may be arranged to be spaced apart from each other.

Additionally, the water supply tank 481 and the drain tank 485 may have lengths along the front and rear direction of the cabinet 110 that are greater than lengths along the height direction of the cabinet 110. This is to maximally utilize the compact space of the auxiliary chamber 150.

(a) in FIG. 4 shows the steam supply 450, the air supply 410, the water supply tank 481, and the drain tank 485 disposed inside the auxiliary chamber 150. The laundry treating apparatus 100 may further include the air supply 410 located inside the auxiliary chamber 150 to circulate or heat air in the first chamber 130, and the steam supply 450 that generates steam and supplies the steam to the first chamber 130.

The air supply 410 may include an air supply duct 411 that sucks air from the first chamber 130, a discharge duct 419 that discharges air to the first chamber 130, and a connecting duct 413 that connects the air supply duct 411 with the discharge duct 419 to circulate air. The air supply 410 may further include a blowing unit 412 that generates a suction force to suck air from the first chamber 130. The blowing unit 412 may be located between the connection duct 413 and the discharge duct 419 or between the air supply duct 411 and the connection duct 413.

The air supply duct 411 will be in communication with the air intake port 137, and the discharge duct 419 will be in communication with the air discharge port 138.

Considering that the air intake port 137 and the air discharge port 138 are arranged in the left and right direction of the cabinet 110, the air supply duct 411, the connecting duct 413, and the discharge duct may also be arranged along the width direction. Accordingly, air circulating in the first chamber 130 may form an air flow that circulates along the left and right direction of the cabinet 110 until it is discharged from the air discharge port 138 and introduced into the air intake port 137.

That is, air discharged from the air discharge port 138, which is located close to one side surface of both side surfaces of the cabinet 110, will ascend along said one side surface and then descend along the other side surface of both side surfaces of the cabinet 110 to be introduced into the air intake port 137.

A heat exchanger (not shown) for heat exchange with circulating air may be further included inside the connecting duct 413. The heat exchanger may be formed as a heater, but may be formed as a heat pump in terms of energy efficiency. The heat pump may include an evaporator and a condenser for heat exchange with a refrigerant.

Accordingly, the heat exchanger may cool and dehumidify air sucked via the air supply duct 411 via the heat exchange with the refrigerant circulating through the heat exchanger, and then heat the air again to create high-temperature dry air. The high-temperature dry air may be again supplied into the first chamber 130 to dry the laundry hung in the first chamber 130.

To place the electric devices or the mechanical devices in the space of the auxiliary chamber 150 as efficiently as possible, the laundry treating apparatus 100 may further include a base 470 that forms a bottom surface of the auxiliary chamber 150, and a supporter 489 that defines a predetermined installation area on the base 470.

The steam supply 450 may be located in the installation area, and the connecting duct 413 including the heat exchanger may be located above the supporter 489. The space of the auxiliary chamber 150 may be used more efficiently by being divided in the height direction of the cabinet 110.

A controller 490 may also be located inside the auxiliary chamber 150. The controller 490 may control the steam supply 450, the air supply 410, the laundry support to be described later, the opening/closing driver, various sensors and an inputter/outputter, a second chamber lighting 590, and a shelf lighting 587.

Referring to (a) in FIG. 4, it is shown that the controller 490 is located between the steam supply 450 and the base 470, but this is only an example and the controller 490 may be located elsewhere. For example, the controller 490 may be located between the cabinet top surface 112 and the first chamber top surface 132. Alternatively, the controller 490 may be disposed inside the door assembly 500. Alternatively, the controller 490 may be located close to the cabinet rear surface 115 at the rear of the auxiliary chamber 150.

The water supply tank 481 and the drain tank 485 may be located between the connecting duct 413 and the first chamber bottom surface 135. This is because an extra space is defined above the connecting duct 413 because of a vertical dimension of the discharge duct 419 and the water supply tank 481 and the drain tank 485 are able to be installed using such space.

Accordingly, inside the auxiliary chamber, the base 470, the steam supply 450, the connecting duct 413, the water supply tank 481, and the drain tank 485 may be arranged sequentially from the bottom along the height direction.

(b) in FIG. 4 shows a lay-out of a compressor 417 included in the mechanical device. This is to compress the refrigerant and circulate the same via the heat exchanger. The refrigerant will exchange heat with air circulating through the air supply 410. Air circulating in the first chamber 130 via the heat exchanger will be supplied to the first chamber 130 in the high-temperature and dry state.

The compressor 417 may be located on one side of the supporter 489. Considering a size and vibration of the compressor 417, the compressor 417 may be located closer to the cabinet rear surface 115 than to the auxiliary chamber front surface 151 or the first inlet 131.

Referring to (b) in FIG. 4, it is shown that the supporter 489 is composed of a first supporter 4891 and a second supporter 4892 to support the steam supply 450 and the air supply 410. Each of the first supporter 4891 and the second supporter 4892 may include two legs and a mounting portion connecting the two legs to each other.

In contrast, the supporter 489 is formed by a rectangular mounting portion extending in the width direction of the cabinet 110, and front and rear mounting surfaces that extend from front and rear side surfaces among side surfaces of the mounting portion and are coupled to the base 470, respectively. In other words, the supporter 489 may be formed as one member rather than as two separate members like the first supporter 4891 and the second supporter 4892. That is, one member may form a rectangular parallelepiped shape together with the base 470, and the steam supply 450 may be located inside the rectangular parallelepiped shape.

(a) in FIG. 5 shows an example in which the door assembly 500 is opened and the first chamber 130 is exposed to the outside. Additionally, (a) in FIG. 5 shows an example of an inputter/outputter 700 disposed on the front surface of the door assembly 500 or on the front surface of the door 530 of the second chamber. The inputter/outputter 700 may receive control information from the user to operate the laundry treating apparatus 100. Additionally, the inputter/outputter 700 may inform the user of a performance state (or information of a current treatment state) of the laundry treating apparatus 100 based on the control information of the user. The present disclosure shows an example in which the inputter/outputter 700 is visually displayed on the front surface of the door assembly 500, but unlike this, the inputter/outputter 700 may further include a speaker, a haptic device, and the like that may inform the user of the information also via hearing or touch.

The user may cause the laundry treating apparatus 100 to perform a desired operation via the inputter/outputter 700 by touching the inputter/outputter 700 with hand. Alternatively, the user may cause the laundry treating apparatus 100 to perform the desired operation by pressing or touching a button disposed on the inputter/outputter 700. The inputter/outputter 700 may have an inputter that receives the command of the user and an outputter that outputs the state of the laundry treating apparatus 100 separated from each other.

The controller 490 may sense and process an user input via the inputter/outputter 700, and display the state of the laundry treating apparatus 100 or results via the inputter/outputter 700.

In one example, the door assembly 500 may be relatively heavy, unlike a regular door, because of the second chamber 550 included inside. Therefore, it may be difficult for the user to open and close the door assembly 500 manually. Additionally, considering design, the door assembly 500 may not have a separate handle for manually opening and closing the door assembly 500.

To this end, the laundry treating apparatus 100 may further include the opening/closing driver 170 that pushes the door assembly 500 to open the same when the user wishes to open the door assembly 500. The controller 490 may control the opening/closing driver 170 to open the door assembly 500.

The inputter/outputter 700 may include a door opening inputter 711 that senses a door opening command of the user. For example, when the user selects a door opening menu in the inputter/outputter 700, the controller 490 may sense the same and operate the opening/closing driver 170 to open the door assembly 500.

Alternatively, the laundry treating apparatus 100 may include a proximity sensor 791 disposed in the door assembly 500. Accordingly, when the user is located within a predetermined sensing area of the proximity sensor 791, the controller 490 may sense user's approach and may operate the opening/closing driver 170 to open the door assembly 500.

The proximity sensor 791 may be located in the front surface of the door assembly 500, that is, in the door 530 of the second chamber. For example, the proximity sensor 791 may be located adjacent to the inputter/outputter 700.

Alternatively, the laundry treating apparatus 100 may open the door assembly 500 by operating the opening/closing driver 170 when the user inputs the door opening command via an app or a remote controller.

(a) in FIG. 5 shows the opening/closing driver 170 with an upper opening/closing driver 175 located at an upper portion and a lower opening/closing driver 177 located at a lower portion inside the cabinet 110. Alternatively, one opening/closing driver 170 among the upper opening/closing driver 175 and the lower opening/closing driver 177 may be implemented to open the door assembly 500.

(b) in FIG. 5 shows the internal space of the first chamber 130 divided into the first area 1301 and the second area 1302 when viewed from one side surface of the cabinet 110. (b) in FIG. 5 simply schematically shows a relative locational relationship of the first chamber 130, the second chamber 550, and the auxiliary chamber 150.

That is, considering that, when the door assembly 500 closes the first inlet 131, at least the portion of the second chamber 550 is located in the second area 1302, which is located closer to the first inlet 131 than to the rear surface of the first chamber 130 inside the first chamber 130, at least the portion of the accommodating body 510 will be located in the second area 1302 when the door assembly 500 closes the first inlet 131.

Additionally, to hang the laundry inside the first chamber 130, the user may access the first area 1301 through the first inlet 131 and the second area 1302. That is, a laundry support 600 to be described later will be located in the first area 1301 when the door assembly 500 is closed.

Accordingly, at least the portion of the second chamber 550 will be accommodated in the space between the first inlet 131 and the auxiliary chamber 150 when the door assembly 500 closes the first inlet 131.

In this regard, the rear surface of the door assembly 500, that is, at least a portion of an accommodating body rear surface 5105 (see FIG. 7), specifically, a lower portion of the accommodating body rear surface 5105, may face the auxiliary chamber front surface 151. Another portion of the accommodating body rear surface 5105, specifically an upper portion of the accommodating body rear surface 5105, will face the first chamber rear surface 136.

In one example, an embodiment in which the second chamber 550 is located upward of the auxiliary chamber 150 may also be considered. However, a space located under the second chamber 550 may have a problem of defining a stagnant area in which air does not circulate well.

In addition, the first chamber 130 and the second chamber 550 may be in communication with each other, but in this case, when treating the laundry inside the first chamber 130, the laundry located inside the second chamber 550 should also be treated, so that the laundry accommodated in the second chamber 550 is not able to be separately cared for. Additionally, when the first chamber 130 and the second chamber 550 are simply in communication with each other, the condensate generated because of a temperature difference between the first chamber 130 and the second chamber 550 is not able to be treated. For example, when steam is sprayed into the first chamber 130, the steam may enter the second chamber 550 and generate the condensate in the second chamber 550, but because the first chamber 150 is operating, the condensate generated in the second chamber 550 may be treated.

In one example, a bottom surface of the first area 1301 corresponds to the first bottom surface 1351 of the stepped first chamber bottom surfaces 135, and a bottom surface of the second area 1302 corresponds to a second chamber bottom surface 1352.

Considering the weight of the door assembly 500 and the sizes of the various electrical devices or mechanical devices accommodated inside the auxiliary chamber 150, a length FR2 in the front and rear direction of the second area 1302 may be equal to or smaller than a length FR1 in the front and rear direction of the first area 1301 along the front and rear direction of the cabinet 110. This is because there is the risk of overturning of the laundry treating apparatus 100 because of the weight of the door assembly 500 when the length FR2 in the front and rear direction of the second area 1302 exceeds the length FR1 in the front and rear direction of the first area 1301.

In addition, no empty space is created between the accommodating body 510 and the auxiliary chamber 150 because of the second chamber 550, so that not only may the spaces of the first chamber 130 and the second chamber 550 be used more efficiently, but also may the stagnant area that may cause flow stagnation during the air circulation be eliminated.

In one example, a vertical dimension of the second chamber 550 may be greater than a vertical dimension of the first chamber 130. This is because the vertical level of the first bottom surface 1351 is higher than the vertical level of the second bottom surface 1352 because of a vertical dimension of the auxiliary chamber 150. Accordingly, the second chamber 550 may accommodate therein laundry relatively longer than the laundry accommodated in the first chamber 130.

Specifically, the vertical dimension of the second chamber 550 may be greater than that of the first area 1301.

Referring to (b) in FIG. 5, the vertical dimension of the first area 1301 (or a length from the first chamber top surface 132 to the first bottom surface 1351) may be smaller than the vertical dimension of the second area 1302 (or a length from the first chamber top surface 132 to the first bottom surface 1351). This is because the vertical dimension of the auxiliary chamber 550 located under the first area 1301 should be considered.

That is, the first chamber bottom surface 135 will be formed in the stepped shape by including the first bottom surface 1351 and the second bottom surface 1352, which has the relatively lower vertical level than the first bottom surface 1351 because of the auxiliary chamber 150 located under the first chamber bottom surface 135.

The second chamber 550 formed inside the door assembly 500 will be accommodated in the second area 1302. Accordingly, the length of the second chamber 550 may be greater than the length of the first area 1301. That is, the second chamber 550 may accommodate therein the laundry relatively longer than the laundry accommodated in the first chamber 130. Accordingly, the user will be able to accommodate laundry of various lengths in the laundry treating apparatus 100 and care for the laundry.

Additionally, the auxiliary chamber 150 may serve as a stopper to prevent the door assembly 500 from being pushed back any further. The door assembly 500 will be located in the second area 1302 located on the second bottom surface 1352 inside the first chamber 130. That is, the lower portion of the accommodating body 510, which forms at least a portion of an outer appearance of the door assembly 500, will face the auxiliary chamber front surface 151. Ultimately, even when an unintended external force is applied to the door assembly 500 and the door assembly 500 is pushed into the first chamber 130, the auxiliary chamber 150 may prevent the door assembly 500 from moving into the first chamber 130 by a certain depth or more.

Considering that the laundry is accommodated in the first area 1301, the vertical dimension of the first area 1301 will be greater than the vertical dimension of the auxiliary chamber 150.

Additionally, to prevent the overturning caused by the weight of the door assembly 500, a length in the front and rear direction of the first area 1301 will be equal to or greater than a length in the front and rear direction of the second area 1302.

Considering that at least the portion of the second chamber 550 is inserted into the second area 1302, an area multiplied by a width and a height of the second area 1302 will be greater than an area of the second chamber rear surface 555. That is, an open area of the first inlet 131 will be greater than the area of the second chamber rear surface 555.

A vertical dimension of the front surface of the door assembly 500 will be greater than the vertical dimension of the second area 1302. That is, a vertical dimension of the first inlet 131 will be smaller than a front surface vertical dimension of the door 530 (see FIG. 2) of the second chamber.

(a) and (b) in FIG. 6 illustrate an operating principle of the opening/closing driver 170. (a) in FIG. 6 shows the door assembly 500 in a closed state, and (b) in FIG. 6 shows the door assembly 500 in an open state.

The opening/closing driver 170 may push the door assembly 500 forward, causing the door assembly 500 to be withdrawn in a direction away from the first inlet 131. Thereafter, the user may pull or push a side surface of the door assembly 500 using a gap created between the door assembly 500 and the first inlet 131 to move the door assembly 500 to one side of the cabinet 110.

It may be preferable that, during the opening and the closing of the door assembly 500, the front surface of the door assembly 500 is maintained to face forward at all times. This is because, as the inputter/outputter 700 (see FIG. 5) disposed in the front surface of the door assembly 500 always faces forward, the user may easily access the inputter/outputter 700, and air inside the second chamber 550 may be circulated to care for the laundry or the goods accommodated inside the second chamber 550.

That is, even when the first chamber 130 is open, the user may execute a care mode of the second chamber 550. In other words, the door assembly 500 may be constructed to move away from the first inlet 131 such that the front surface of the door assembly 500 faces forward, and then move to one side of the cabinet 110 such that the front surface of the door assembly 500 is parallel to the first inlet 131. To this end, the laundry treating apparatus 100 according to the present disclosure may use a scheme of kinematic parallelogram four-bar linkages.

Accordingly, the user may open and close the door assembly 500 while maintaining the first inlet 131 and the door assembly 500 facing away from each other. Accordingly, the door assembly 500 may maintain the direction parallel to the first inlet 131 during the opening and the closing.

That is, an angle between the front surface of the cabinet 110 and the door assembly 500 may be maintained constant. To this end, the first hinge 120 may move the door assembly 500 forward of the first chamber 130 to separate the same from the first inlet 131 and then move the door assembly 500 along the width direction of the cabinet 110. That is, even when the location of the door assembly 500 changes, the direction the door assembly 500 faces may remain the same when opening and closing the first inlet 131. This is because when the door assembly 500 opens the first inlet 131, the front surface of the door assembly 500 moves while being directed in the forward direction of the cabinet 110, in the same manner as when the door assembly 500 closes the first inlet 131.

However, in a case of opening and closing the second inlet 512, the direction in which the front surface of the door 530 of the second chamber faces may change. Unlike the first hinge 120, when the second hinge 520 opens the door 530 of the second chamber, the second inlet 512 and the door 530 of the second chamber pivot relative to each other, so that an angle between the second inlet 512 and the door 530 of the second chamber may always change (see FIG. 8).

Referring to (a) in FIG. 6, the laundry treating apparatus 100 may further include the opening/closing driver 170 that pushes the door assembly 500 to open the door assembly 500. The opening/closing driver 170 may be disposed between the cabinet top surface 112 and the first chamber top surface 132 that forms the top surface of the first chamber 130. For example, the opening/closing driver 170 may be coupled to a lower side of the cabinet top surface 112. Alternatively, the opening/closing driver 170 may be disposed at a lower side of the first chamber top surface 132.

One opening/closing driver 170 may be sufficient, but there may be a plurality of opening/closing drivers. The opening/closing driver 170 may be disposed not only between the cabinet top surface 112 and the first chamber top surface 132, but also on the first chamber bottom surface 135 that forms the bottom surface of the first chamber. Alternatively, the opening/closing driver 170 may be located between the first chamber bottom surface 135 and the bottom surface of the cabinet 110.

The reason why there are the plurality of opening/closing drivers 170 is to push the door assembly 500 from the upper and lower sides to prevent the deformation of the door assembly 500 or the hinge structure that couples the door assembly 500 to the cabinet from occurring as the force is concentrated on one side or the unnecessary torque is generated.

The opening/closing driver 170 may not be in contact with the accommodating body 510. The laundry treating apparatus 100 may further include the first hinge 120 in the four-bar linkages scheme. (b) in FIG. 6 shows a state in which the opening/closing driver 170 pushes the door assembly 500 forward and thus the door assembly 500 is away from the first inlet 131.

The opening/closing driver 170 may include an opening/closing body 171 forming an outer appearance thereof, an opening/closing motor 173 located inside the opening/closing body 171, and an opening/closing link 172 that pushes the door assembly 500 to move the same in the direction away from the first inlet 131 using a rotational force generated by the opening/closing motor 173.

One surface of the opening/closing link 172 may have gear teeth, so that the opening/closing link 172 may move in the front and rear direction of the cabinet 110 in a rack and pinion-like manner. That is, when several gears engage and rotate with a rotation shaft of the opening/closing motor 173 to reduce a rotational speed, and some of the gears engage and rotate with the gear teeth disposed on one surface of the opening/closing link 172, as the opening/closing link 172 moves forward and protrudes, the door assembly 500 may move in the direction away from the first inlet 131.

(a) in FIG. 6 shows an example in which the opening/closing link 172 is formed in a curved shape. This is to prevent the opening/closing driver 170 from taking up a significant portion of a space inside the first chamber as a length in the front and rear direction thereof increases, considering a length that the opening/closing link 172 moves in the front and rear direction. In addition, this is because, when the door assembly 500 is withdrawn forward by the first hinge 120, both links 1251 and 1252 of the first hinge 120 may pivot and thus a spacing therebetween may increase, and at this time, a moving path of the door assembly 500 may be in a curved shape rather than a straight shape. Even in such case, the front surface of the door assembly 500 may move while always facing forward.

When the opening/closing driver 170 pushes the door assembly 500 and a gap or a predetermined separation distance (or an opening distance) is created between the first inlet 131 and the door assembly 500, the user may manually push or pull the door assembly 500 to move the same.

Accordingly, a maximum moving distance of the opening/closing link 172 may be a distance until the accommodating body 510, which was inserted into the first chamber 130, is withdrawn from the first inlet 131.

When the opening/closing link 172 moves the door assembly 500 by the predetermined opening distance, the controller 490 may rotate the opening/closing motor 173 in an opposite direction, so that the opening/closing link 172 may move to be inserted back into the opening/closing body 171. This is because, when the opening/closing link 172 does not return to an original location thereof, the door assembly 500 may collide with the opening/closing link 172 as the closing of the door assembly 500 is performed by the user, unlike the opening.

Accordingly, considering the case in which the user closes the door assembly 500, the controller 490 may return the opening/closing link 172 to the original location thereof by rotating the opening/closing motor 173 in the opposite direction.

That is, to move the opening/closing link 172 from a first location, which is an initial location, to a second location defined ahead of the first location, the controller 490 may rotate the opening/closing motor 173 in a first direction. The opening/closing link 172 is not in contact with the door assembly 500 in the first location, but will be in contact with the door assembly 500 while moving to the second location. Thereafter, the opening/closing driver 170 will move the door assembly 500 in the forward direction of the cabinet 110 by the predetermined opening distance.

Thereafter, when the opening/closing motor 173 rotates in a second direction opposite to the first direction, the opening/closing link 172 may return from the second location to the first location.

Additionally, because the opening/closing driver 170 does not need to be operated when the door assembly 500 is closed, the controller 490 will operate the opening/closing driver 170 only when the door assembly 500 is opened.

Even when the user closes the door assembly 500, the front surface of the door assembly 500 may always be maintained facing forward.

As shown in (b) in FIG. 6, the door assembly 500 may be moved with the front surface always facing forward. This is because the second chamber 550 is not only for caring for and storing the laundry or the goods accommodated, but also for displaying and exhibiting the laundry or the goods. Therefore, this is to ensure that the user may always see the second chamber 550. In addition, even when the first chamber 130 is open, the inputter/outputter 700 disposed in the front surface of the door assembly 500 always faces forward, so that the user may easily access the inputter/outputter 700. Therefore, to care for the laundry or the goods accommodated inside the second chamber 550, the user may circulate air inside the second chamber 550 via the inputter/outputter 700 regardless of whether the first chamber 130 is opened.

To this end, the laundry treating apparatus 100 may be equipped with the first hinge 120 of the parallelogram four-bar linkages type. That is, while pivotably connecting the door assembly 500 to the cabinet 110, the first hinge 120 may open and close the door assembly 500 such that the front surface of the door assembly 500 always faces forward.

(a) and (b) in FIG. 7 show the laundry treating apparatus 100 and furniture F1 and F2 disposed adjacent to the laundry treating apparatus 100. This is illustrated considering that the laundry treating apparatus 100 is disposed together with general furniture in a built-in type.

As shown, the second chamber 550 may be located in front of the first chamber 130. Additionally, because the door assembly 500 includes the second chamber 550 therein, at least the portion of the accommodating body 510 may be inserted into the first chamber 130.

Considering the built-in type, a height and a depth FD1 of the laundry treating apparatus 100 will be designed in consideration of a size of the furniture F1 and F2 disposed adjacently. Here, the depth FD1 refers to the length in the front and rear direction of the laundry treating apparatus 100. The second chamber 550 may be disposed at a side of the laundry treating apparatus 100, but in this case, the width occupied by the laundry treating apparatus 100 becomes too great, which will not be desirable.

Additionally, to utilize the second chamber 550 not only for caring for the laundry but also for the display and exhibition purposes, it will be desirable for the second chamber 550 to be located in front of the first chamber 130 and the auxiliary chamber 150.

In addition, because placing objects to overlap each other in the depth direction of the second chamber 550 is not suitable for the display and exhibition purposes, a depth SD1 of the door assembly 500 will be smaller than the depth FD1 of the laundry treating apparatus.

However, it may not be desirable for the second chamber 550 to protrude beyond the laundry treating apparatus 100 in consideration of sense of unity with the adjacent furniture. Accordingly, to not change the depth FD1 of the laundry treating apparatus, the portion of the second chamber 550 may be inserted into the first chamber 130.

When the portion of the door assembly 500 is inserted into the first chamber 130, a problem may occur when opening the door assembly 500 because of the size of the door assembly 500. (a) and (b) in FIG. 7 show an arc with a radius of DR centered on one side of the cabinet 110.

When the door assembly 500 is hinged to one side of the cabinet 110, a distance from one side of the cabinet 110 to a point indicated by IA, that is, a corner where the accommodating body rear surface 5105 and an accommodating body right side surface 5103 meet each other when the door assembly 500 pivots should be considered. This is to prevent the corner from interfering with one side surface of the first chamber 130. Ultimately, when the door assembly 500 is hinged to one side of the cabinet 110, the depth SD1 of the door assembly 500 or the width of the accommodating body rear surface 5105 should be reduced.

When the door assembly 500 is hinged to the other side of the cabinet 110, interference of an opposite corner should be considered. However, because the problem is the same, only the case in which the door assembly 500 is hinged to one side is described herein.

The depth (or a thickness) of the door assembly 500 may be equal to or greater than ⅙ and equal to or smaller than ½ of the length in the front and rear direction of the cabinet 110. This is in consideration of a size of the goods accommodated in the second chamber 550. For example, it may be a numeric value determined by considering a small standard size and a large standard size of bags carried by adult women.

Considering such numeric value, there may be a limit in reducing the depth SD1 of the door assembly 500 or a width SW1 of the accommodating body rear surface 5105.

In addition, referring to (b) in FIG. 7, because the hinge causes interference with the adjacent furniture F2 in an area indicated by IB, the laundry treating apparatus 100 and the adjacent furniture F2 should be spaced by a certain distance apart from each other.

Even when the door assembly 500 opens without the interference, a portion of the first inlet 131 may be obscured by the accommodating body 510, causing inconvenience to the user. Here, “obscured” refers to a case in which the angle formed by the first inlet 131 and the door assembly 500 is an acute angle.

To solve such problem, referring to FIG. 8, the laundry treating apparatus 100 may include the cabinet 110 including the first inlet 131 defined in the front surface thereof, the first chamber 130 located inside the cabinet 110 and accommodating the laundry therein through the first inlet 131, the auxiliary chamber 150 located at the lower side inside the cabinet 110 and forming the installation space therein separate from the first chamber 130, the door assembly 500 that opens and closes the first inlet 131, and the first hinge 120 that connects the door assembly 500 to the cabinet, and the door assembly 500 may include the accommodating body 510 including the second inlet 512 defined in the front surface thereof, the second chamber 550 located inside the accommodating body 510 and formed to be separated from the first chamber 130 and the auxiliary chamber 150, and accommodating the laundry therein through the second inlet 512, the door 530 of the second chamber that opens and closes the second inlet 512, and the second hinge 520 that connects the door 530 of the second chamber to the accommodating body 510.

The first hinge 120 may open and close the first inlet 131 such that the open direction of the second inlet 512 is maintained when the door assembly 500 is opened and closed, and the second hinge 520 may open and close the second inlet 512 via the pivoting of the door 530 of the second chamber.

Maintaining the opening direction of the second inlet 512 means that the door assembly 500 moves while maintaining the direction thereof when the door assembly 500 is opened or closed. When the user is located in front of the door assembly 500, the user will face the second chamber 550. Even when the user opens or closes the door assembly 500, the direction of the door assembly 500 does not change, so that the user may always check the second chamber 550.

In other words, the link disposed in the first hinge 120 pivots, but the second chamber 550 may always face forward via pivoting and translation of the door assembly 500. Accordingly, the door assembly 500 will move in the front and rear direction or the width direction of the cabinet 110 in parallel with the first inlet 131 to open and close the first inlet 131.

In other words, when the door assembly 500 has opened or has closed the first inlet 131 or is opening or closing the first inlet 131, a location and a direction from one arbitrary point of the door assembly 500 to another arbitrary point will not change.

The laundry treating apparatus 100 may include the first hinge 120 connecting the door assembly 500 to the cabinet 110 between both side surfaces of the cabinet 110. The first hinge 120 may be located at the upper portion and/or the lower portion inside the cabinet 110. Specifically. The first hinge 120 may include a first upper hinge 128 disposed on the first chamber top surface 132 and a first lower hinge 129 disposed on the first chamber bottom surface 135.

The first chamber top surface 132 may have a stepped shape. Accordingly, the first chamber top surface may include a stepped surface 1323 (see FIG. 14) resulted from a step height. This is to secure a space where the opening/closing driver 170 is installed between the cabinet top surface 112 and the first chamber top surface 132.

In this case, the first upper hinge 128 may be located in front of the stepped surface 1323 on the first chamber top surface 132.

The first lower hinge 129 may be located in front of the auxiliary chamber 150 or on the second bottom surface 1352.

Referring to FIG. 8, it may be seen that, in the first upper hinge 128 and the first lower hinge 129 included in the first hinge 120, a pivoting length of the links 1251 and 1252 connecting the cabinet with the door assembly 500 is greater than a pivoting length of connecting members 5251 and 5252 of the second hinge 520 connecting the door 530 of the second chamber with the accommodating body 510. This is to prevent the interference with the adjacent furniture by completely separating the door assembly 500 from the cabinet when opening the door assembly 500 or during the opening of the door assembly 500. In addition, this is to prevent the door assembly 500 from obscuring the first inlet 131 when the door assembly 500 is completely opened.

On the other hand, as shown in FIG. 8, when the door 530 of the second chamber is opened while the door assembly 500 is open, the interference with the adjacent furniture resulted from the door 530 of the second chamber will not occur. However, when the door 530 of the second chamber is opened while the door assembly 500 is closed, the interference with the adjacent furniture may occur. Therefore, it will be desirable for the second hinge 520 to be constructed so as not to protrude to the outside of the cabinet 110 when the door 530 of the second chamber is closed.

To this end, lengths of the first link 1251 (see (b) in FIG. 10) and the second link 1252 (see (b) in FIG. 10), which will be described later in FIG. 10, may be greater than lengths of a first connecting member 5251 (see (c) in FIG. 12) and a second connecting member 5252 (see (c) in FIG. 12).

Referring to FIG. 9, the door assembly 500 may include the accommodating body 510 including the second inlet 512 defined in the front surface thereof and the second chamber 550 therein, and the door 530 of the second chamber that opens and closes the second inlet 512.

More specifically, referring to FIGS. 3 and 9, the second chamber 550 may be formed by the accommodating housing 559 located inside the accommodating body 510. The user may access the second chamber 550 through the second inlet 512.

More specifically, the door assembly 500 may further include a front panel 518 coupled to the front surface of the accommodating body 510. The second inlet 512 may be defined through the front panel 518.

Accordingly, the door assembly 500 may further include the front panel 518 formed to face the door 530 of the second chamber while surrounding the second inlet 512 and coupled to the accommodating housing 559 and the accommodating body 510.

Alternatively, the front panel 518 may be formed integrally with the accommodating housing 559 and then be coupled to the accommodating body 510 with the open front surface.

Accordingly, the front panel 518 may be coupled to the front surfaces of the accommodating body 510 and the accommodating housing 559, and the laundry treating apparatus 100 may accommodate the laundry or the goods in the second chamber 550 formed inside the accommodating housing 559 through the second inlet 512 extending through the front panel 518.

Because the door 530 of the second chamber may have a size corresponding to a size of the front panel 518 surrounding the second inlet 512, the size of the door 530 of the second chamber may be greater than a size of the second inlet 512.

When the door 530 of the second chamber is closed, the door 530 may be coupled to the front panel 518 to close the second inlet 512.

The second hinge 520 may be coupled to the front panel 518 or the accommodating body 510.

That is, the front panel 518 may include a front upper panel 5181 that forms an upper portion of the front panel, a front lower panel 5184 that forms a lower portion of the front panel, and a front left panel 5182 and a front right panel 5183 that connect respective side surfaces of the front upper panel 5181 and respective side surfaces of the front lower panel 5184 to each other.

The second inlet 512 may be defined by the front upper panel 5181, the front lower panel 5184, the front left panel 5182, and the front right panel 5183. That is, the front panel 518 will be located surrounding the second inlet 512. This is to prevent wires, circuit boards, and various devices that may be located between the second chamber 550 and the accommodating body 510 from being exposed to the user.

The second inlet 512 may be defined in a square shape.

The front upper panel 5181 may include an air inlet 51813 defined through the front upper panel 5181. Air in the second chamber 550 may circulate through the air inlet 51813. The air inlet 51813 may be defined to extend along the width direction of the door assembly 500.

Therefore, when the door 530 of the second chamber is closed, because the air inlet 51813 is located in the front panel 518, the air inlet 51813 will face the door 530 of the second chamber.

The door 530 of the second chamber may be coupled to the front surface of the accommodating body 510, that is, the front panel 518 including the second inlet 512, to open and close the second inlet 512. That is, the door 530 of the second chamber may be coupled to the front panel 518 so as to cover at least an area including the air inlet 51813 and the second inlet 512.

That is, when the door 530 of the second chamber is closed, the second chamber 550 will be in communication with the internal space located between the accommodating body 510 and the second chamber 550 via the air inlet 51813.

Additionally, FIG. 9 shows an example of a hanger assembly 800 and a shelf mounting portion 5552 disposed in the second chamber 550. The hanger assembly 800 may include the laundry hanger 830 that may hang the laundry in the second chamber 550. The laundry hanger 830 may be mounted on or detached from the second chamber rear surface 555 that forms the rear surface of the second chamber 550.

The door assembly 500 may further include the hanger assembly 800 disposed in the second chamber 550 to hang the laundry. The hanger assembly 800 may be mounted on or coupled to a hanger mounting portion 5554 disposed in the second chamber 550. The hanger assembly 800 is a kind of accessory and is detachable from the second chamber 550.

Specifically, the door assembly 500 may further include the hanger mounting portion 5554 that may install or mount the hanger assembly 800 on the second chamber rear surface 555. The hanger mounting portion 5554 may vary depending on a shape of the hanger assembly 800. For example, in a case of the hanger assembly 800, which has an outer appearance of a general ring-shaped hanger, the hanger mounting portion 5554 may be in a shape of a hook protruding from the second chamber rear surface 555. The user may display the laundry by hanging the ring of the hanger assembly 800 on the hook.

In contrast, as shown in FIG. 9, in the case of the laundry hanger 830 coupled to the second chamber rear surface 555, the hanger mounting portion 5554 may be in a form of a groove or a hole in the second chamber rear surface 555. Accordingly, the laundry hanger 830 may be coupled to the hanger mounting portion 5554 in a detachable manner.

In one example, the laundry treating apparatus 100 may further include the shelf 580 (see FIG. 2) that is detachably disposed in the second chamber 550 and supports the goods accommodated in the second chamber 550. In addition, the laundry treating apparatus 100 may further include the shelf mounting portion 5552 for coupling with the shelf that is coupled to the second chamber rear surface 555.

Specifically, the second chamber rear surface 555 may include the shelf mounting portion 5552 in the form of the groove or the hole that extends along the width direction of the door assembly 500.

The shelf 580 may be in a shape of a rectangular sheet. The shelf 580 may include a shelf coupling portion 811 for coupling to the shelf mounting portion 5552 at a rear surface thereof. The shelf mounting portion 5552 may include a plurality of shelf mounting portions. Accordingly, the shelf 580 may also include a plurality of shelves coupled to the shelf mounting portions 5552, respectively.

The shelf mounting portion 5552 is coupled to the second chamber rear surface 555, and this is to separate both side surfaces of the shelf 580 from both side surfaces of the second chamber for air circulation in the second chamber 550, which will be described later.

FIG. 9 shows an example in which the hanger assembly 800 is coupled to one surface of the second chamber 550 and the shelf 580 is separated from the shelf mounting portion 5552. Considering a size of the laundry hung on the hanger assembly 800, only some of the plurality of shelves may be coupled to some of the plurality of shelf mounting portions 5552 located below the hanger assembly 800. Even in a state in which the hanger assembly 800 is not coupled, the user will be able to couple the shelves to the shelf mounting portions 5552 while adjusting a spacing between the plurality of shelves considering the size of the goods or the laundry accommodated in the second chamber. That is, depending on the size of the goods to be accommodated and displayed, the shelf 580 coupled to the rear surface of the second chamber 550 may be removed or coupled.

(a) to (c) in FIG. 10 show the first hinge 120. The opening and closing direction of the door assembly 500 may vary depending on whether the user is left-handed or right-handed. Alternatively, the door assembly 500 may be set to be opened and closed in a direction preferred by the user. The opening and closing direction of the door assembly 500 may be set differently depending on a direction in which the same first hinge 120 is installed. The first hinge 120 shown in (a) and (c) in FIG. 10 will move the door assembly 500 to a left side of the user, and the first hinge 120 shown in (b) in FIG. 10 will move the door assembly 500 to a right side of the user.

Referring to (b) in FIG. 10, the first hinge 120 may include a hinge coupling portion 127 coupled to the door assembly 500, a hinge receiving portion 121 coupled to the cabinet, and a link 125 pivotably connected to the hinge coupling portion 127 and the hinge receiving portion 121. The link 125 may be accommodated in the hinge receiving portion 121 when the door assembly 500 closes the first inlet 131.

The link 125 may include the first link 1251 and the second link 1252 that pivotably connect the hinge receiving portion 121 with the hinge coupling portion 127.

That is, the first hinge 120 may include the first link 1251 and the second link 1252 that are pivotably coupled to the cabinet 110 and the accommodating body 510 but are spaced apart from each other.

The first hinge 120 may move the door assembly 500 forward to be away from the first inlet 131 via the pivoting of the first link 1251 and the second link 1252 and then move the door assembly 500 parallel to the first inlet 131.

Because the first link 1251 and the second link 1252 are connected so as to be pivotable at different points of the hinge receiving portion 121 and the hinge coupling portion 127, an overall outline may be in the form of four-bar linkages. In particular, because the hinge receiving portion 121 and the hinge coupling portion 127 are respectively coupled and fixed to the cabinet 110 and the door assembly 500, only the first link 1251 and the second link 1252 may pivot. Therefore, it may have a similar mechanism to the parallelogram four-bar linkages.

That is, when the first link 1251 and the second link 1252 pivot, the hinge receiving portion 121 and the hinge coupling portion 127 are only able to move to be parallel to each other. Ultimately, the first link 1251 and the second link 1252 will also pivot in parallel with each other by being spaced apart from each other.

The door assembly 500 will move in the direction parallel to the first inlet 131.

The door assembly 500 may move with the door 530 of the second chamber always facing forward. Accordingly, the user may always see the second chamber 550 when opening and closing the door assembly 500.

Additionally, when the door assembly 500 closes the first inlet, the first link 1251 and the second link 1252 may be disposed in the direction parallel to the door assembly 500 and be in contact with the door assembly 500. This may be referred to as the first location or a folded state. When the opening/closing driver 170 pushes the door assembly 500, the door assembly 500 may pivot and be withdrawn forward simultaneously by the first hinge 120. Further, the door assembly 500 will finally be moved to one side of the laundry treating apparatus by the first hinge 120.

The first link 1251 and the second link 1252 of the first hinge 120 pivot, but because they are spaced apart from each other, the front surface of the door assembly 500 always faces forward. Accordingly, it may appear to the user that the door assembly 500 is withdrawn in the direction away from the first inlet 131 and then moves laterally.

Strictly speaking, because the first link 1251 and the second link 1252 pivot at a distance from each other, the door assembly 500 pivots by each individual link. However, because the front surface of the door assembly 500 is always fixed facing forward, the door assembly 500 may appear to be performing the translational motion.

Herein, it is described that the door assembly 500 moves forward by the predetermined distance by the opening/closing driver 170 and then moves laterally. This type of door may be called a gliding door or a swing door.

Considering lengths of the first link 1251 and the second link 1252, the first hinge 120 may open the door assembly 500 without interfering with the adjacent furniture. Additionally, when the door assembly 500 is completely opened, the door assembly 500 moves to one side of the laundry treating apparatus 100 and does not obscure the first inlet. Such state may be referred to as an unfolded state. This is to facilitate access to the inputter/outputter 700 even when the door assembly 500 is opened or moved.

The first link 1251 and the second link 1252 may pivot at an angle greater than 90 degrees (°) and smaller than 180 degrees (°) from the folded state to the unfolded state.

Referring to (c) in FIG. 10, the hinge coupling portion 127 may include an L-shaped hinge bent portion 1275 that is formed to be bent at one side. This is to prevent interference between the first link 1251 and the second link 1252 in the folded state.

FIG. 11 is an example of the second hinge 520. The door assembly 500 may further include the second hinge 520 to pivotably couple the door 530 of the second chamber to the accommodating body 510.

Because a thickness of the door 530 of the second chamber is smaller than a thickness of the door assembly 500 and the door 530 is coupled to the front surface of the accommodating body 510, the second hinge 520 does not need to operate like the first hinge 120. Therefore, unlike the first hinge 120 moving away from the first inlet 131 and then moving in the direction parallel to the first inlet 131, the second hinge 520, like a general hinge, may be located at one side of the accommodating body 510 and pivot the door 530 of the second chamber, thereby opening and closing the door 530 of the second chamber.

However, when the second hinge 520 is constructed to be exposed to the outside, interference with the adjacent furniture may occur, so that the second hinge 520 may be installed on an inner surface of the door 530 of the second chamber, that is, a surface facing the second inlet 512 among both surfaces of the door 530 of the second chamber, and the accommodating body, so that the second hinge 520 may not be exposed to the outside when the door 530 of the second chamber is closed.

Accordingly, a portion of the second hinge 520 may be coupled to the accommodating body 510, and another portion of the second hinge may be coupled to the inner surface of the door 530 of the second chamber.

When the second hinge 520 pivots and the state of the door 530 of the second chamber is changed from the closed state to the open state, a maximum opening angle Θ of the door 530 of the second chamber may be equal to or greater than 90 degrees (°) and smaller than 180 degrees (°). When the maximum opening angle of the door 530 of the second chamber is equal to or greater than 180 degrees (°), the interference with the adjacent furniture may occur.

(a) to (c) in FIG. 12 show an example of the second hinge 520. Like the first hinge 120, the second hinge 520 may include a member receiving portion 521 coupled to the accommodating body 510, a member coupling portion 527 coupled to the door of the second chamber, and a connecting portion 525 connecting the member receiving portion 521 with the member coupling portion 527. The connecting portion 525 may include the first connecting member 5251 and the second connecting member 5252. The member receiving portion 521 may include a receiving portion fastening groove 5211 to be coupled to the accommodating body 510 using a fastening member.

Similar to the member receiving portion 521, the member coupling portion 527 may also include a first fastening hole 5271 and a second fastening hole 5272, which are fastening holes for fixing the member coupling portion 527 to the inner surface of the door 530 of the second chamber.

The second hinge 520 may include a plurality of second hinges, and may include a second upper hinge 528 connecting upper portions of the door 530 of the second chamber and the accommodating body 510 to each other, and a second lower hinge 529 connecting lower portions of the door 530 of the second chamber and the accommodating body 510 to each other. (a) in FIG. 12 is an example of the second upper hinge 528, and (b) in FIG. 12 is an example of the second lower hinge 529. Locations of the first fastening holes 5271 of the second upper hinge 528 and the second lower hinge 529 are opposite to each other. This is because a location of coupling with the door 530 of the second chamber is taken into consideration. That is, because the second upper hinge 528 is located at the upper portion of the door 530 of the second chamber, a fastening area is secured at a lower side. The second lower hinge 529 will be opposite thereto.

Referring to (b) in FIG. 12, when the second hinge 520 fully opens the door of the second chamber, a predetermined clearance distance K1 may exist between the member receiving portion 521 and the member coupling portion 527. This is to prevent interference between the door 530 of the second chamber and the accommodating body 510 in an area HA shown in FIG. 11.

(a) and (b) in FIG. 13 are another example of the laundry treating apparatus 100 described in the present disclosure. The laundry treating apparatus 100 described above includes the door assembly 500 whose volume is increased to accommodate the second chamber 550 inside. On the other hand, the laundry treating apparatus shown in FIG. 13 shows an example of including a door 501 with a relatively small door thickness as the second chamber 550 is not included. That is, this is an example of the laundry treating apparatus 100 in which the space of the first chamber 130 is not divided into the two spaces by the step of the first chamber bottom surface 135.

That is, because the first chamber bottom surface 135 is not stepped, the door 501 may be pivotably coupled to the cabinet 110 to open and close the first inlet (or the inlet) 131. In this regard, the door 501 may have the same structure as the second hinge described above, but may be coupled to the cabinet 110 with an existing hinge. In this case, there may be a predetermined spacing between the furniture and the laundry treating apparatus 100 to prevent interference with the adjacent furniture.

Referring to (a) and (b) in FIG. 13, the laundry treating apparatus 100 according to the present disclosure includes the cabinet 110 including the inlet 131 defined in the front surface thereof, the door 501 that opens and closes the inlet 131, the first chamber 130 that is located inside the cabinet and accommodates therein the laundry or the goods via the inlet 131, the hanger body 610 that is disposed inside the first chamber 130, extends along the front and rear direction of the cabinet 110, and hangs the laundry therein, and the hanger support 620 located on the hanger body 610 and movably supporting the same.

Additionally, the hanger body 610 may be separated from the hanger support 620 and movable forward.

In addition, the auxiliary chamber 150, which is separately disposed under the first chamber 130, may insert and/or withdraw the water supply tank 481 and the drain tank 485 into and/or from the auxiliary chamber 150 via the auxiliary chamber front surface 151 forming the front surface of the auxiliary chamber 150.

(b) in FIG. 13 shows a mechanical device EMA disposed inside the auxiliary chamber 150 to spray air (heated air or unheated air) or steam into the first chamber 130, and a laundry driver 640 disposed between the first chamber top surface 132 and the cabinet top surface 112 to allow the laundry support 600 to perform a reciprocating movement in the front and rear direction of the cabinet 110.

In addition, because the laundry support 600 is disposed in the front and rear direction of the cabinet 110, the air discharge port 138 and the air intake port 137 may be arranged in the width direction of the cabinet 110 to uniformly supply air or steam to the laundry hung on the laundry support 600. In addition, the steam discharge port 139 may also be located adjacent to the air discharge port 138 and extend along the front and rear direction of the cabinet 110 like the air discharge port 138.

FIG. 14 briefly shows the first chamber 130 and the auxiliary chamber 150 and then schematically shows an air circulation direction. As described in FIGS. 3 and 4, at least a portion of the door assembly 500 may be inserted into the first chamber 130. Accordingly, because the length in the front and rear direction of the auxiliary chamber 150 located under the first bottom surface 1351 is reduced, the air supply duct 411 will be located closer to one of both side surfaces of the cabinet 110 to efficiently place the mechanical devices inside the auxiliary chamber 150. That is, the air supply duct 411 will be disposed in a direction facing the one side surface.

Alternatively, as described above, referring to (a) and (b) in FIG. 13, even in the case of the door 501 without the second chamber 550, to reduce the length in the front and rear direction of the cabinet 110, the laundry support 600 may be disposed in the front and rear direction of the cabinet 110. In any case, as the laundry support 600 is disposed in the front and rear direction of the cabinet 110, the air discharge port 138 and the air intake port 137 may be disposed along the width direction of the cabinet 110 perpendicular to the direction of the laundry support 600. This is to supply air or steam evenly to the laundry being hung.

Considering this, to efficiently place the mechanical device EMA inside the auxiliary chamber 150, the air supply duct 411 will be located close to one of both side surfaces of the cabinet 110. That is, the air supply duct 411 will be disposed in a direction facing the one side surface.

The connecting duct 413 may also be disposed in the left and right direction or the width direction of the cabinet 110.

The supporter 489 may also be disposed in the left and right direction of the cabinet 110.

Ultimately, a flow of air circulating through the air supply 410 may be shown as shown in FIG. 14. FIG. 14 shows the first chamber 130 viewed from the first inlet (or the inlet) 131.

Referring to FIG. 14, assuming that the air discharge port 138 is located on one side surface among both side surfaces of the first chamber and the air intake port 137 is located on the other side surface among both side surfaces of the first chamber 130, air discharged via the air supply 410 will flow upward toward the first chamber top surface 132 along one side surface of the first chamber via the air intake port 137. Thereafter, the flow direction of air will change by the first chamber top surface 132, and air will meet the other side surface of the first chamber 130 and flow downward again.

Ultimately, air that has flowed along the other side surface of the first chamber 130 will flow to the air supply 410 via the air intake port 137.

Air introduced into the air intake port 137 will first flow downward along the air supply duct 411. Thereafter, air will pass through the blowing unit 412 and flow upward again toward the connecting duct 413. This is because the connecting duct 413 is located above the supporter 489, while the blowing unit 412 is located on the base 470.

That is, the air flow from the air supply duct 411 to the connecting duct 413 will go down and then go up again. This is to prevent condensate that may be introduced via the air supply duct 411 from flowing into the heat exchanger 415 together. The condensate may be separated from air at a lower portion of the air supply duct 411 before being introduced into the blowing unit 412 as the flow direction of air changes.

The laundry treating apparatus 100 may further include a sump (not shown) for temporarily storing the condensate at the lower portion inside the air supply duct 411 or outside the air supply duct 411. The condensate temporarily collected in the sump (not shown) may be collected in the drain tank 485 via a drain pump (not shown).

Steam supplied via the steam supply 450 (see FIG. 4) may also be circulated in the same manner. However, instead of the air discharge port 138, steam may be discharged via the steam discharge port 139 and then enter the air supply duct 411 together with air circulating via the air intake port 137.

In one example, according to the present disclosure, as the circulation direction of air and steam in the laundry treating apparatus 100 is set to the left and right direction rather than the front and rear direction, a direction of the laundry support 600, especially the hanger body 610, for hanging the laundry may also be set differently.

To care for the laundry, air and steam should be evenly distributed throughout the laundry. When the hanger body 610 is disposed in the width direction, only laundry hung close to the air discharge port 138 and the steam discharge port 139 may be cared for and laundry hung far away may not be cared for well because of the laundry hung close thereto. Therefore, for uniform distribution of air and steam, it will be desirable for the laundry support 600 to be disposed along the front and rear direction of the cabinet 110.

However, it may be inconvenient for the user to hang the laundry on the laundry support 600. This is because distances from the inlet 131 to the hanger grooves 6111 are all different as the plurality of hanger grooves 6111 defined in the laundry support 600 are arranged in the front and rear direction. Therefore, hanging the laundry in the deepest hanger groove may cause discomfort to the user.

To solve such problem, the laundry treating apparatus 100 may include the laundry support 600 disposed along the front and rear direction of the cabinet 110, and the hanger body 610 including the plurality of hanger grooves 6111 in the laundry support 600 may be extendable forward. Accordingly, the user will be able to extend the hanger body 610 forward via the first inlet 131 and hang the laundry without the inconvenience of having to bend down.

FIG. 15 is an exploded view of an example of the laundry support 600 disposed in the first chamber 130. The laundry support 600 may include the hanger body 610 disposed along the front and rear direction of the cabinet 110 to hang the laundry thereon, and a hanger support 620 disposed along the front and rear direction of the cabinet 110 and located on the hanger body 610 to support the hanger body 610.

The laundry support 600 may further include the laundry driver 640 that generates a rotational force and a power converter 660 that converts the rotational movement of the laundry driver 640 into a reciprocating movement along the front and rear direction of the cabinet 110.

The laundry driver 640 may be located between the first chamber top surface 132 and the cabinet top surface 112 to prevent exposure to the user and to prevent breakdown caused by steam and hot air supplied to the first chamber.

Additionally, the laundry driver 640 may be supported by a hanger frame (not shown) that supports the laundry driver 640. The hanger frame may also be located between the first chamber top surface 132 and the cabinet top surface 112, and both ends of the hanger frame may be coupled to the cabinet frame (not shown) that forms a skeleton of the cabinet 110 or the cabinet 110. This is to prevent vibration of the laundry driver 640 from being transmitted into the first chamber 130.

The laundry driver 640 may include a power motor 641 and a power transmitter 642 that is connected to a rotation shaft of the power motor and transmits power to the power converter. FIG. 15 shows a driving pulley 6423, a driven pulley 6422, and a belt 6421 connecting the driving pulley 6423 with the driven pulley 6422 as an example of the power transmitter 642, but the present disclosure may not be limited thereto.

In addition, the laundry driver 640 may further include a pulley fixing member 6425 that is supported on the moving hanger frame and supports the driven pulley 6422.

The power converter 660 may include a rotatable portion 661 that is connected to the driven pulley 6422 and rotates together when the driven pulley 6422 rotates, and a converting member 662 that converts the rotation of the rotatable portion 661 into a reciprocating movement. The rotatable portion 661 may perform a circular motion of a certain radius by the rotatable portion 661 constructed to rotate at a distance from a rotation shaft direction of the driven pulley 6422.

Specifically, the rotatable portion 661 may include a rotatable connecting member connected to the rotation shaft at one end, an arm member connected to the other end of the rotatable connecting member in a direction perpendicular to the rotation shaft, and inserted rotatable member connected to the converting member 662 in a direction parallel to the rotation shaft at the other end of the arm member.

FIG. 15 shows that the converting member 662 is defined at an upper side of the hanger support 620 in a form of a groove or a hole defined along the front and rear direction of the cabinet 110, but the present disclosure is not limited thereto.

The hanger support 620 may include a first support 622 and a second support 624 that support both ends of the hanger support, respectively. The first support 622 and the second support 624 will support the hanger support 620 when the hanger support 620 performs the reciprocating movement along the front and rear direction by the converting member 662.

The laundry support 600 may include the hanger body 610 that is located below the hanger support 620 so as to be spaced apart therefrom and hangs the laundry thereon. The hanger support 620 and the hanger body 610 may extend along the front and rear direction of the cabinet 110.

The hanger support 620 and the hanger body 610 may be coupled to each other to perform the reciprocating movement by the laundry driver 640.

The hanger body 610 may include the plurality of hanger grooves 6111 where the laundry may be hung. FIG. 14 shows the plurality of hanger grooves 6111 arranged at spacings that are not uniform. This is to allow thin laundry, for example, a dress shirt to be additionally hung. For example, FIG. 14 shows five hanger grooves. Among them, first, third, and fifth hanger grooves are spaced apart from each other at an uniform spacing, and second and fourth hanger grooves are located close to the first and fifth hanger grooves, respectively. The first, third, and fifth hanger grooves are hanger grooves that are arranged considering the size of the laundry. On the other hand, the second and fourth hanger grooves may be used to additionally hang the laundry.

The hanger body 610 is coupled to the hanger support 620, but is extendable forward via the first inlet 131 when necessary. That is, the hanger support 620 may further include a moving rail 615 for moving the hanger body 610 forward. The hanger body 610 may further include a moving guider 617 that is located on the hanger body 610 and couples the hanger body 610 to the moving rail 615. When the moving guider 617 moves on the moving rail 615, the hanger body 610 may move in the front and rear direction along the moving rail 615.

Referring to FIGS. 15 and 16, the hanger body 610 may further include a hanger bar 611 including the plurality of hanger grooves 6111 for hanging the laundry. The hanger body 610 may further include an upper hanger body 612 located on the hanger bar 611 to prevent interference with the moving rail 615 or the laundry support 600 when the user hangs the laundry in the hanger grooves 6111.

The hanger bar 611 and the upper hanger body 612 may be spaced apart from each other and face away from each other. The hanger bar 611 and the upper hanger body 612 may be located to be spaced apart from each other and to be parallel with each other to define a hanging space 6101, which is a space accessible to the user for hanging the laundry. The hanger bar 611 and the upper hanger body 612 may be coupled to each other by each connecting body 619 connecting each of both ends of the hanger bar 611 with each of both ends of the upper hanger body 612.

That is, the hanging space 6101 may be defined by the hanger bar 611, the upper hanger body 612, and each connecting body 619 connecting each of both ends of the hanger bar 611 with each of both ends of the upper hanger body 612.

In other words, the hanger body 610 may include the hanging space 6101 defined through the cabinet 110 in the width direction when the hanger body 610 is disposed in the front and rear direction of the cabinet 110. The plurality of hanger grooves 6111 where the laundry may be hung may be located in a bottom surface of the hanging space 6101.

FIG. 16 shows an example in which the hanger body 610 extends forward of the hanger support 620. The user may extend the hanger body 610 forward from the hanger support 620, hang the laundry, and then retract the hanger body 610 rearwards again.

Specifically, the laundry support 600 may be located along the front and rear direction of the cabinet 110 in the first area 1301. When the laundry support 600 is located in the first area 1301, the hanger bar 611 will be fixed to the upper hanger body 612 and will perform the reciprocating movement along the front and rear direction of the cabinet 110 along with the upper hanger body 612 when the laundry driver 640 rotates. Thereafter, when the door assembly 500 is opened, the user may extend the hanger bar 611 from the upper hanger body 612 and move the same in a direction toward the first inlet 131.

That is, when the door assembly 500 is opened, the hanger bar 611 may be extended from the upper hanger body 612 toward the first inlet, and at least a portion of the hanger bar 611 may be located in the second area 1302.

FIG. 17 shows an example in which the water supply tank 481 and drain tank 485 are separated via the auxiliary chamber front surface 151. The auxiliary chamber front surface 151 may include a first accommodating hole 1511 extending through the auxiliary chamber front surface 151. The user may attach and detach the water supply tank 481 to and from a tank installation space (not shown) defined inside the auxiliary chamber 150 via the first accommodating hole 1511.

That is, the laundry treating apparatus 100 may include the cabinet 110 including the inlet 131 defined in the front surface thereof, the door 501 that opens and closes the inlet 131, the first chamber 130 located in the cabinet 110 and accommodating the laundry therein via the inlet 131, the first chamber bottom surface 135 forming the bottom surface of the first chamber 130, the auxiliary chamber 150 located under the first chamber 130 separated therefrom inside the cabinet 110, the steam supply 450 that is disposed in the auxiliary chamber 150 and supplies steam to the first chamber 130, the air supply duct 411 disposed in the auxiliary chamber 150, located close to one side surface among both side surfaces of the cabinet 110, and into which air of the first chamber 130 is introduced, the discharge duct 419 disposed in the auxiliary chamber 150 and located close to the other side surface among both side surfaces of the cabinet 110 to discharge air introduced into the air supply duct 411 into the first chamber 130, the connecting duct 413 disposed in the auxiliary chamber 150 and connecting the air supply duct 411 with the discharge duct 419, a tank installation space TIS (see FIG. 20) defined between the connecting duct 413 and the first chamber bottom surface 135, and the water supply tank 481 detachably located in the tank installation space TIS to supply water to the steam supply 450.

The auxiliary chamber front surface 151 may include a second accommodating hole 1515 extending through the auxiliary chamber front surface 151. The user may attach and detach the water supply tank 481 to and from the tank installation space TIS defined inside the auxiliary chamber 150 via the first accommodating hole 1511.

FIG. 17 shows that the water supply tank 481 and the drain tank 485 may be retracted into and extended from the auxiliary chamber 150 via the first accommodating hole 1511 and the second accommodating hole 1515, respectively. However, otherwise, the water supply tank 481 and the drain tank 485 may be formed as one integrated tank. In this case, the auxiliary chamber front surface 151 may include only one accommodating hole corresponding to the one integrated tank.

Alternatively, the water supply tank 481 and the drain tank 485 may be arranged adjacent to each other via one accommodating hole.

(a) in FIG. 18 shows another example of the steam discharge port 139, the air discharge port 138, and the air intake port 137. Referring to (a) in FIG. 18, the air discharge port 138 and the air intake port 137 may be arranged along the width direction of the cabinet 110.

The steam discharge port 139 may be located closer to the air discharge port 138 than to the air intake port 137. This is to prevent steam from being sucked via the air intake port 137 as soon as it is discharged via the steam discharge port 139.

Referring to (a) in FIG. 18, the steam discharge port 139 may be located at the rear of the air discharge port 138. That is, the steam discharge port 139 may be located farther from the inlet 131 than the air discharge port 138. This is to reduce condensation of steam discharged via the steam discharge port 139 resulted from a temperature difference with the outside at the door 501 that opens and closes the inlet 131.

Additionally, like the air discharge port 138 and the air intake port 137, the steam discharge port 139 may extend along the front and rear direction of the cabinet 110.

(b) in FIG. 18 is an exaggerated illustration of the laundry treating apparatus 100 viewed in a direction toward the inlet 131. The first chamber bottom surface 135 (the first bottom surface 1351 in the case of being stepped) may be inclined via the air intake port 137 to discharge the condensate generated in the first chamber 130. Accordingly, when viewed from the front, a vertical level near the air discharge port 138 will be higher than a vertical level near the air intake port 137 in the first chamber bottom surface 135, and the first chamber bottom surface 135 may be inclined downward toward the air intake port 137.

Therefore, considering both side surfaces L1 and L2 of the cabinet 110, the first chamber bottom surface 135 may be inclined from one side surface of the cabinet toward the other side surface.

(c) in FIG. 18 is an exaggerated illustration viewed from one side surface of the cabinet 110. For the same reason, the first chamber bottom surface 135 may be inclined from a rear side R to a front side F.

Therefore, referring to (b) and (c) in FIG. 18, the lowest area of the first chamber bottom surface will be an area indicated by LBOT in (a) in FIG. 18.

FIG. 19 shows another example of the mechanical device assembly EMA. As described above, it may be seen that the locations of the steam discharge port 139 and the air discharge port 138 are different from those in the mechanical device assembly shown in FIG. 4. To this end, air that has passed through the connecting duct 413 will be supplied from the discharge duct 419 to the first chamber 130 via the air discharge port 138, which is biased more toward the inlet 131 than to the first chamber rear surface 136.

(a) in FIG. 20 is a cross-section of the mechanical device assembly EMA viewed from the front. (b) in FIG. 20 is a cross-section of the mechanical device assembly EMA viewed from the side. (a) in FIG. 21 is an example of the mechanical device assembly EMA viewed from the front. (b) in FIG. 21 is another example of the mechanical device assembly EMA viewed from the front.

Referring to (a) in FIG. 20, air introduced via the air intake port 137 may pass through the air supply duct 411 and flow to the blowing unit 412. The blowing unit 412 may include a blowing fan 4122 that sucks air from the first chamber 130 via the air supply duct 411, a blowing casing 4121 in which the blowing fan 4122 is located, a blowing inlet 4121a in which a portion of one surface of the blowing casing 4121 is opened to flow air sucked via the air supply duct 411 to the blowing fan 4122, and a blowing vent 4123 for allowing air that has passed through the blowing fan 4122 to flow to the connecting duct 413.

Based on the height direction of the cabinet 110, a vertical level of the blowing vent 4123 may be higher than a vertical level of the blowing inlet 4121a. Air that has descended via the air supply duct 411 is supposed to rapidly change in direction via the blowing fan 4122. This is to remove the condensate condensed from air introduced via the air supply duct 411. In addition, air that has passed through the blowing fan 4122 flows again to the connecting duct 413 located upward of the blowing inlet 4121a, which is to maximally use the narrow space.

Referring to (a) in FIG. 20 and (b) in FIG. 21, the water supply tank 481 and the drain tank 485 may be located between the connecting duct 413 and the first chamber bottom surface 135 based on the height direction of the cabinet 110. Additionally, the water supply tank 481 and the drain tank 485 may be located between the air supply duct 411 and the discharge duct 419 based on the width direction of the cabinet 110.

That is, the laundry treating apparatus 100 may include the tank installation space TIS formed between the connecting duct 413 and the first chamber bottom surface 135 along the height direction of the cabinet and extending along the front and rear direction of the cabinet. Additionally, the tank installation space TIS may be located between the air supply duct 411 and the discharge duct 419 based on the width direction of the cabinet 110.

The laundry treating apparatus 100 may further include a water supply tank accommodating casing 4818 coupled to the auxiliary chamber front surface 151 inside the auxiliary chamber 150.

The tank installation space TIS may be formed by the water supply tank accommodating casing 4818.

When also considering the drain tank 485, the laundry treating apparatus 100 may further include the water supply tank accommodating casing 4818 coupled to the auxiliary chamber front surface 151 inside the auxiliary chamber 150, and a drain tank accommodating casing 4858 coupled to the auxiliary chamber front surface 151 inside the auxiliary chamber 150. The tank installation space TIS may be formed by the water supply tank accommodating casing 4818 and the drain tank accommodating casing 4858.

Referring to (a) in FIG. 20 and (a) in FIG. 26, it may be seen that a bottom surface 4818 (see (a) in FIG. 26) of the water supply tank accommodating casing, and a bottom surface 4858 (see (a) in FIG. 26) of the drain tank accommodating casing are spaced apart from a connecting duct top surface 4131, which forms a top surface of the connecting duct 413.

This is to prevent heat from the heat exchanger 415 located inside the connecting duct 413 from being unnecessarily transferred to the water supply tank 481 and the drain tank 485.

That is, referring to (a) in FIG. 21, the bottom surface 4818 (see (a) in FIG. 26) of the water supply tank accommodating casing and the bottom surface 4858 (see (a) in FIG. 26) of the drain tank accommodating casing may be spaced apart from the connecting duct upper surface 4131 by a predetermined separation distance TL. This is to insulate the water supply tank 481 and the drain tank 485 from the outside, especially the heat exchanger 415.

Referring to (b) in FIG. 4 and (b) in FIG. 20, it may be seen that the compressor 417 for compressing and circulating the refrigerant is located closer to the cabinet rear surface 115 than to the inlet 131.

That is, the compressor 417 may be located inside the auxiliary chamber 150 closer to the rear side of the auxiliary chamber 150 than to the inlet 131, and may compress the refrigerant and circulate the same via the heat exchanger 415. Because it is to prevent an overturning accident of the laundry treating apparatus 100, which may occur when the laundry driver 640 is operated, in advance via an arrangement of the compressor 417 because a weight of the compressor 417 is great.

Referring to (b) in FIG. 20, based on the height direction of the cabinet 110, the steam supply 450, the heat exchanger 415, and the water supply tank 481 may overlap each other. The compressor 417 may be located at the rear of the steam supply 450. Additionally, the steam supply 450 may be located spaced apart from the base 470. This is to prevent heat generated from the steam supply 450 from being directly transferred to the base 470.

Referring to (a) in FIG. 21, the laundry treating apparatus 100 may further include a water supply pump 4825 that supplies water stored in the water supply tank 481 to the steam supply 450. Additionally, the water supply tank 481 and the steam supply 450 will be connected to each other via a water supply pipe 4821.

The water pump 4825 may be located between the steam supply 450 and the water supply tank 481 based on the height direction of the cabinet 110. This is to simplify a water supply flow channel formed by the water supply pipe 4821 as much as possible.

To this end, the steam supply 450 may also be disposed to be biased in the same direction as the water supply tank 481. Referring to (a) in FIG. 21, it may be seen that both the steam supply 450 and the water supply tank 481 are located closer to the right side surface of the cabinet 110 than to the left side surface of the cabinet 110.

Additionally, the water pump 4825 may be located closer to the inlet 131 than to the first chamber rear surface (not shown), which is the rear surface of the first chamber 130, along the front and rear direction of the cabinet 110. This is because the water pump 4825 may receive unnecessary heat when the water pump 4825 is located above the compressor 417. To this end, the water supply pipe 4821 may also pass through a space between the water supply tank 481 and the connecting duct top surface 4131 and be connected to the steam supply 450.

Referring to (b) in FIG. 21, the laundry treating apparatus 100 may further include the heat exchanger 415 that is disposed inside the connecting duct 413 and exchanges heat with air sucked by the blowing unit 412.

The heat exchanger 415 may include a first heat exchanger 4155 that cools air sucked by the blowing unit 412, and a second heat exchanger 4157 that heats air that has passed through the first heat exchanger 4155. When the first heat exchanger 4155 is an evaporator, the second heat exchanger 4157 may be a condenser.

Therefore, air sucked from the first chamber 130 will be dehumidified and heated via the heat exchanger 415, converted into dry hot air, and supplied again to the first chamber 130.

In one example, the heat exchanger 415 may, alternatively, include a heater (not shown). Air passing through the inside of the connecting duct 413 may be heated directly via the heater.

Referring to (a) in FIG. 20 and (b) in FIG. 20, a sump 484 may be located at a lower portion inside or at a lower portion outside the air supply duct. The sump 484 is to temporarily collect the condensate. The condensate introduced via the air supply duct 411 will fall downward because of a weight thereof when the direction of air changes from the air supply duct 411 to the blowing fan 4122. Therefore, this is because the condensate may be collected in the sump using the same.

Additionally, the sump 484 may store the condensate generated while air passes through the heat exchanger 415. To this end, the laundry treating apparatus 100 may further include a pipe (not shown) connecting the lower portion of the connecting duct 413 with the sump 484.

FIG. 22 is a view of the mechanical device assembly EMA from another angle. As described above, to prevent the overturning accident of the laundry treating apparatus 100, the heavy compressor 417 will be located at the rear side rather than the front side.

The condensate collected in the sump 484 may be discharged to the drain tank 485 by a drain pump 4865, when necessary. The drain pump 4865 may be located on the base 470. This is in consideration of a vertical level of the sump 484. That is, to minimize residual water in the sump 484, it will be desirable for the drain pump 4865 to be installed at a vertical level equal to or lower than that of the sump 484.

The drain pump 4865 may be located closer to the drain tank 485 than to the water supply tank 481. Additionally, the drain pump 4865 may be located closer to the first chamber rear surface (not shown) than to the inlet 131 along the front and rear direction of the cabinet 110. This is to place the drain pump 4865 on an opposite side of the water supply pump 4825, considering an arrangement with the water supply pump 4825.

A drain flow channel may be formed between the sump 484 and the drain tank 485. The drain flow channel will be formed via a drain pipe 4861.

FIG. 23 shows the air supply duct 411, the connecting duct 413, and the discharge duct 419. The air supply duct 411 may include an air supply duct body 4111 connected to the blowing unit 412, and an air supply duct guide 4112 connecting the air supply duct body 4111 with the air intake port 137.

The air supply duct body 4111 may further include an air supply duct inlet 4111a connected to the air supply duct guide, and a length of the air supply duct inlet 4111a along the front and rear direction of the cabinet 110 may be greater than a length of the air supply duct inlet 4111a along the width direction of the cabinet 110.

This is because, as the air intake port 137 extends in the front and rear direction of the cabinet 110, the air supply duct guide 4112 and the air supply duct 411 are also formed in similar shapes corresponding thereto.

The air supply duct guide 4112 may be disposed to extend a height of the air supply duct 411 in consideration of a vertical level of the discharge duct 419. Therefore, the tank installation space TIS may be located between the air supply duct 411 and the discharge duct 419 based on the width direction of the cabinet 110. Alternatively, the tank installation space TIS may be located between the air supply duct guide 4112 and the discharge duct 419.

The connecting duct 413 may include a duct inlet 4131 connecting the connecting duct 413 with the blowing unit 412, and a duct outlet 4133 connecting the connecting duct 413 with the discharge duct 419.

The duct inlet 4131 and the duct outlet 4133 may be arranged along the width direction of the cabinet 110. That is, as the hanger body 610 is disposed in the front and rear direction of the cabinet 110, the arrangement of the air discharge port 138 and the air intake port 137 changes, and thus, the direction in which the connecting duct 413 extends is also able to change.

The discharge duct 419 may be formed in an inclined shape along the height direction of the cabinet 110 toward the air discharge port 138. Accordingly, an empty space next to the discharge duct 419 may define a space SNS where a steam nozzle (not shown), which is disposed to discharge steam generated from the steam supply 450 to the steam discharge port 139, may be located.

The laundry treating apparatus 100 may further include an air supply cover 4113 to protect the air intake port 137 and a discharge cover 4193 to protect the air discharge port 138 and the steam discharge port 139. The air supply cover 4113 may have a louver shape including a plurality of through-holes. The discharge cover 4193 may be formed in an integrated shape to protect both the air discharge port 138 and the steam discharge port 139. Alternately, the discharge cover 4193 may be constructed to separately and individually cover the air discharge port 138 and the steam discharge port 139.

FIG. 24 is an enlarged rear view of a tank installation space. The water supply tank 481 and the drain tank 485 may be accommodated in the water supply tank accommodating casing 4818 and the drain tank accommodating casing 4858, respectively, and may be extended and/or retracted via the auxiliary chamber front surface 151.

In FIG. 24, to show a connection relationship between the water supply tank 481 and the drain tank 485, the water supply tank accommodating casing 4818 and the water supply tank 481 are omitted.

Referring to FIG. 24 and (a) in FIG. 25, the water supply tank 481 may include a water supply tank body 4811 that defines a storage space for storing water, a water supply tank body rear surface 4817 that forms a rear surface of the storage space among surfaces of the water supply tank body 4811, a water supply tank body bottom surface 4812 that forms a bottom surface of the storage space, and a water supply tank body front surface 4814 that forms a front surface of the storage space.

In addition, the water supply tank 481 may further include a water supply valve 4816 located on the water supply tank body rear surface 4817 and connected to a water supply connecting portion 4815 to discharge water stored in the storage space.

The water supply valve 4816 may be a check valve. The water supply valve 4816 will be connected to the water supply connecting portion 4815 when the water supply tank 481 is introduced into the water supply tank accommodating casing 4818. The water supply connecting portion 4815 may be connected to the water supply pump 4825 and the steam supply 450 via the water supply pipe 4821.

Because the water supply pump 4825 is located closer to the inlet 131 than to the cabinet rear surface 115, the water supply pipe 4821 will be connected to the water supply pump 4825 via a space defined between the water supply tank accommodating casing 4818 and the connecting duct top surface 4131 spaced apart from each other as soon as it comes out of the water supply connecting portion 4815. This is because, when the water supply pipe 4821 passes through a space below a connecting duct bottom surface (not shown), the water supply pipe 4821 will descend to a location lower than the water supply pump 4825, so that there may be a load on the water supply pump 4825 and there may be a risk of being exposed to unnecessary heat coming from the compressor 417.

Likewise, referring to FIG. 24 and (b) in FIG. 25, the drain tank 485 may include a drain tank body 4851 that defines a water collection space for storing the condensate, a drain tank body bottom surface 4852 that forms a bottom surface of the water collection space, a drain tank body front surface 4854 that forms a front surface of the water collection space, and a drain tank body rear surface 4857 that forms a rear surface of the water collection space.

The drain tank 485 may further include a drain valve 4856 located in the drain tank body rear surface 4857 and for receiving the condensate via the drain pump.

The laundry treating apparatus 100 may further include a drain connecting portion 4855 connected to the drain valve 4856 when the drain tank 485 is retracted into the drain tank accommodating casing 4858.

The drain connecting portion 4855 may be formed in a shape of a protruding nozzle 4855a. The protruding nozzle 4855a will be connected to the drain valve 4856. Unlike the water supply valve 4816, the drain valve 4856 may simply be in a shape of a hole defined through the drain tank body rear surface 4857.

Ultimately, the drain connecting portion 4855 will be connected to the drain pump 4865 by the drain pipe 4861.

To connect the water supply connecting portion 4815 and the drain connecting portion 4855 with the water supply valve 4816 and the drain valve 4856, respectively, the water supply tank accommodating casing 4818 and the drain tank accommodating casing 4858 may include through-holes (not shown) extending through the water supply tank accommodating casing 4818 and the drain tank accommodating casing 4858 corresponding to locations of to the water supply valve 4816 and the drain valve 4856, respectively.

The water supply valve 4816 may be located at a lower side of the storage space to minimize the residual water in the water supply tank 481. Conversely, the drain valve 4856 may be located at an upper side of the water collection space to discharge the condensate into the drain tank 485.

That is, the water supply valve 4816 may be located closer to the water supply tank body bottom surface 4812 than to a water supply tank body top surface 4813. On the other hand, the drain valve 4856 may be located closer to a drain tank body top surface 4853 than to the drain tank body bottom surface 4852. Additionally, the drain valve 4856 may be located closer to one side surface of the drain tank body 4851 than to the other side surface. Ultimately, the drain valve 4856 may be located at an upper portion at one side of the drain tank body rear surface 4857. Accordingly, the user will be able to check whether the water supply tank 481 and the drain tank 485 are properly coupled to the storage casings corresponding thereto, respectively.

A diameter of the water supply valve 4816 may be greater than a diameter of the drain valve 4856. This is because a water supply rate and a condensate discharge rate are different from each other.

The drain valve 4856 may open and close a portion of the drain tank body rear surface 4857 when the drain tank 485 is accommodated in the drain tank accommodating casing 4858.

(a) in FIG. 25 shows an example of the water supply tank 481. Among the lengths of the water supply tank body 4811, a length WST1 based on the front and rear direction of the cabinet 110 may be greater than a length WST2 based on the width direction of the cabinet 110 and lengths WST3 to WST5 based on the height direction of the cabinet 110. This is in consideration of a size of the tank installation space TIS.

Referring to (a) and (b) in FIG. 25, the height WST4 of the water supply tank body front surface 4814 may be greater than the height WST5 of the water supply tank body rear surface 4817. This is to cause the storage space to be inclined downward toward the water supply tank body rear surface 4817. Accordingly, the residual water in the water supply tank 481 may be minimized by directing the water stored in the storage space toward the water supply valve 4816.

To this end, the water supply tank 481 may further include a water supply tank front surface extension 4811a extending downwardly of the water supply tank body bottom surface 4812 in the water supply tank body front surface 4814, and a water supply tank body rear surface extension 4811a extending downwardly of the water supply tank body bottom surface 4812 in the water supply tank body rear surface 4817. A length of the water supply tank front extension 4811a may be greater than a length of the water supply tank rear extension 4811a.

(b) in FIG. 25 shows an example of the drain tank 485. Among the lengths of the drain tank body 4851, a length DT1 based on the front and rear direction of the cabinet 110 may be greater than a length DT2 based on the width direction of the cabinet 110 and lengths DT3 to DT5 based on the height direction of the cabinet 110. This is in consideration of a size of the tank installation space TIS.

Likewise, the height DT4 of the drain tank body front surface 4854 may be greater than the height DT5 of the drain tank body rear surface 4857. This is to enable the condensate to fill the water collection space as much as possible, considering the location of the drain valve 4856.

To this end, the drain tank 485 may further include a drain tank front surface extension 4851a extending downwardly of the drain tank body bottom surface 4852 in the drain tank body front surface 4854, and a drain tank rear surface extension 4851a extending downwardly of the drain tank body bottom surface 4852. A length of the drain tank front surface extension 4851a may be greater than a length of the drain tank rear surface extension 4851a.

(a) in FIG. 26 shows the tank installation space defined between the first chamber bottom surface 135 and the connecting duct top surface 4131. As described above, to minimize influence of heat generated from the heat exchanger 415, the water supply tank 481 and the drain tank 485 may be spaced apart from the connecting duct top surface 4131 by the separation distance TL.

(b) in FIG. 26 shows one cross-section showing that the water supply tank 481 is accommodated in the water supply tank accommodating casing 4818. A front portion ST of the water supply tank accommodating casing may be formed in a stepped shape. This may prevent an excessive force from being applied when the water supply tank 481 is retracted into the water supply tank accommodating casing 4818 and the water supply connecting portion 4815 and the water supply valve 4816 are coupled to each other, and provide guidance for the user on how far the water supply tank 481 should be retracted into the tank accommodating casing 4818. This may also be applied to the drain tank 485 and the drain tank accommodating casing 4858.

The present disclosure may be modified and implemented in various forms, so that the scope of rights thereof is not limited to the above-described embodiments. Therefore, when the modified embodiment includes components of the patent claims of the present disclosure, it should be regarded as falling within the scope of the rights of the present disclosure.

1-60. (canceled)

61. A laundry treating apparatus comprising:
a cabinet including an inlet defined in a front surface thereof;
a door configured to open and close the inlet;
a first chamber located in the cabinet and configured to accommodate laundry therein via the inlet;
an auxiliary chamber located separately and beneath the first chamber within the cabinet;
a blowing unit disposed in the auxiliary chamber and configured to circulate air in the first chamber;
an air supply duct disposed in the auxiliary chamber, located close to one side surface among both side surfaces of the cabinet, and configured to allow air of the first chamber to flow to the blowing unit;
a connecting duct disposed in the auxiliary chamber and including a heat exchanger for heat exchange between air that has passed through the blowing unit and a refrigerant; and
a discharge duct disposed in the auxiliary chamber, located close to the other side surface among said both side surfaces of the cabinet, and configured to allow air that has passed through the connecting duct to flow to the first chamber.

62. The laundry treating apparatus of claim 61, further comprising a compressor located inside the auxiliary chamber closer to a rear side of the auxiliary chamber than to the inlet and configured to compress the refrigerant and circulate the refrigerant via the heat exchanger.

63. The laundry treating apparatus of claim 61, further comprising a hanger body disposed inside the first chamber, extending along a front and rear direction of the cabinet, and configured to hang the laundry thereon.

64. The laundry treating apparatus of claim 61, further comprising:
an air intake port extending through the first chamber and configured to allow air in the first chamber to flow to the air supply duct; and
an air discharge port extending through the first chamber and configured to discharge air that has passed through the discharge duct into the first chamber.

65. The laundry treating apparatus of claim 64, wherein the air intake port and the air discharge port are arranged along a width direction of the cabinet.

66. The laundry treating apparatus of claim 61, further comprising a steam supply disposed in the auxiliary chamber and configured to supply steam to the first chamber,
wherein the steam supply is located downwardly spaced apart from the connecting duct.

67. The laundry treating apparatus of claim 61, further comprising the heat exchanger disposed inside the connecting duct and configured to exchange heat with air sucked by the blowing unit,
wherein the heat exchanger includes:
a first heat exchanger configured to cool air sucked by the blowing unit; and
a second heat exchanger configured to heat air that has passed through the first heat exchanger.

68. The laundry treating apparatus of claim 66, further comprising:
a first chamber bottom surface forming a bottom surface of the first chamber;
a tank installation space defined between the connecting duct and the first chamber bottom surface; and
a water supply tank detachably located in the tank installation space and configured to store water to be supplied to the steam supply.

69. The laundry treating apparatus of claim 68, further comprising a drain tank detachably located in the tank installation space and configured to store condensate generated by the air passing through the heat exchanger.

70. The laundry treating apparatus of claim 68, wherein the water supply tank is withdrawable from the tank installation space through a front surface of the auxiliary chamber.

71. The laundry treating apparatus of claim 69, wherein the drain tank is withdrawable from the tank installation space through a front surface of the auxiliary chamber.

72. The laundry treating apparatus of claim 61, further comprising:
a first chamber bottom surface forming a bottom surface of the first chamber;
a steam supply disposed in the auxiliary chamber and configured to supply steam to the first chamber;
a steam discharge port extending through the first chamber bottom surface to supply steam generated from the steam supply to the first chamber;
an air intake port extending through the first chamber bottom surface and configured to allow air of the first chamber to flow to the air supply duct; and
an air discharge port extending through the first chamber bottom surface and configured to discharge air that has passed through the discharge duct into the first chamber,
wherein the first chamber bottom surface is inclined downward toward the air intake port.

73. The laundry treating apparatus of claim 72, wherein in the first chamber bottom surface, the air intake port is located at a vertical level lower than a vertical level of the steam discharge port along a width direction of the cabinet.

74. The laundry treating apparatus of claim 72, wherein the first chamber bottom surface is inclined downward in a direction toward the inlet.

75. The laundry treating apparatus of claim 74, wherein a portion of the air intake port closer to the inlet than to a rear surface of the cabinet is located at a vertical level lower than a vertical level of another portion of the air intake port.
